(19) United States
(12) Patent Application Publication
(10) Pub. No.: US 2023/0230153 A1
(43) Pub. Date: Jul. 20, 2023

(54) MODULAR MULTI-PARTY POINTS OF TRANSACTION FOR DIGITAL BUSINESS

(71) Applicant: Katalys LLC, Encinitas, CA (US)

(72) Inventors: Aleks Jakulin, New York City, NY (US); Primo{hacek over (z)} Zaj{hacek over (s)}ek, Ljubljana (SI); Ashur Barrett Kalb, Warwick, NY (US)

(21) Appl. No.: 18/096,841

(22) Filed: Jan. 13, 2023

Related U.S. Application Data
(60) Provisional application No. 63/299,509, filed on Jan. 14, 2022.

(51) Int. Cl. G06Q 30/0601; G06Q 30/0241

(52) U.S. Cl. CPC G06Q 30/0643; G06Q 30/0277

(57) ABSTRACT

A computer-implemented method, computer-readable medium, and system may be used to sell products by a merchant via a publisher website hosted by a publisher. Content may be received from the publisher website, wherein the content is associated with a product. A web page including the content may be displayed for a user, and first user input may be received from the user indicating interest in the product. Responsive to the first user input, product information about the product may be received from a merchant distinct from the publisher and, without navigating away from the publisher's website, the product information may be displayed. Further, without navigating away from the publisher's website, second user input indicating a desire to purchase the product may be displayed, and, responsive to the second user input and without navigating away from the publisher's website, an order to purchase the product may be received by the merchant.

### CROSS-REFERENCE TO RELATED APPLICATION

This application claims the benefit of U.S. Provisional Patent Application Ser. No. 63/299,509, filed on Jan. 14, 2022 and entitled “Modular Multi-Party Points of Transaction for Digital Business.” The foregoing is incorporated by reference as though set forth herein in its entirety.

### TECHNICAL FIELD

The present document relates to systems and methods for efficiently executing business transactions using a system of interconnected software processes on behalf of two or more stakeholders connected via the Internet.

### BACKGROUND

People have become accustomed to transacting online. A common example of a digital transaction is an e-commerce purchase, starting with the visitor, an example of which may be a buyer of a product, noticing a product, researching it, and finally purchasing it. This process often involves several companies and sites, including for example: the advertising network that drives a visitor to a media site, the media site where the visitor discovers a product, the affiliate network site where the visitor's browser is marked for attribution, the merchant site where the visitor inserts the order, and a payment site or technology where the visitor completes the payment. Additional web technologies may be involved in various steps from advertising to subscriptions to fulfillment.

There are several problems with existing approaches, including for example:
Visitors often have a suboptimal experience, being redirected from site to site, creating a discontinuous experience;
Visitors' personal data is often shared with several businesses, many of which have no actual need of the data to carry out the purpose of a visitor's visit;
Visitors often have to trust a new merchant website with which they have little or no knowledge or experience;
Merchants' marketing expenditures may be very large compared to their return on investment;
Merchants often lose data to middlemen in their transactions;
Merchants often have to invest a great deal of effort into establishing trust with both visitors and media;
Merchants often have to accept intrusive tracking scripts, allow external data access, and facilitate audits of their data;
Merchants often have to manage many technical integration points;
Publishers generate transaction revenue on merchant properties, and often have to rely on merchants to report attributed sales with very limited ability to audit accounting;
Publishers often must redirect visitors away from their properties to monetize those visitors;
Publishers often may have a conflict of interest through unclear incentives in existing business models;
API integrations are often one-sided such that the side providing an API may be in a superior position to whoever integrates with it; and
JS/HTML integrations are often one-sided such that whoever is providing a tracking script may be in a superior position to whoever integrates with it.

Some publishers implement their own e-commerce systems. However, this model can have a number of flaws: it can create a conflict of interest with merchants, it requires publishers to operate in an area outside their core competencies, it prevents publishers from remaining neutral with respect to mer chants and advertisers, and it imposes an additional middleman for both visitors and merchants.

Some merchants sell through marketplaces that visitors already know. However, this can create a conflict of interest between marketplaces and merchants, where marketplaces will leverage the information and trust to favor other merchants or themselves with store brands. Marketplaces also create channel conflict, where the visitor might not know which channel offers the best terms.

Some merchants form networks by sharing visitor information with each other. However, this can create a conflict of interest between payment services and merchants, along with personal information liabilities.

### SUMMARY

For a market to function well, sellers and buyers need to find each other and trust each other. Historically, fairs, exchanges, market squares, and other types of markets have acted as environments in which buyers and sellers may be aggregated so that they can find each other more easily. In these instances, the exchanges tend to take place directly between buyers and sellers, and the organizers of the markets may attempt to support fairness by providing standardized weights and the like.

More recently, retailers have bought wholesale from sellers, presenting a broader assortment of products to buyers, and providing some assurance of quality. “Brands” have emerged as ways for manufacturers to maintain their differentiation and assurances of quality even as they lose direct control of the transaction. Retailers act as aggregators of supply and of demand.

Online marketplaces aggregate sellers, enforcing and regulating some elements of the transaction. Because the power of online marketplaces is often extraordinarily concentrated, there may be an increasing lack of competition, deteriorating quality of results and consistency of service. Antitrust efforts in this direction have had limited impact.

There is an opportunity to support the creation of true digital markets that facilitate direct transactions between buyers and sellers without intermediaries. The system described herein allows any suitable website or application to serve as a digital market, while facilitating direct transactions that can add value and increase efficiency in electronic commerce.

The techniques described herein may address the concentration problem extant in conventional electronic commerce environments, for example by increasing focus on transaction costs through the application of Transaction Costs Theory as described, for example, at haps://www.sciencedirect.com/topics/social-sciences/transaction-coststheory. The following are examples of transaction cost components in the context of commerce.

### Customer's (Buyer's) Costs:

cA) cost of finding a product
cB) cost of evaluating the product
cC) cost of evaluating & agreeing to the terms
cD) cost of executing a purchase
cE) cost of enforcing or undoing the terms of the purchase

### Seller's (Merchant's/Vendor's/Retailer's) Costs:

sA) cost of finding a buyer
sB) cost of creating a relationship with a market
sC) cost of communicating quality to the buyer
sD) cost of selling to the buyer
sE) costs of buyer fraud
sF) costs of information loss to markets
sG) costs of paying commissions

### Market's Costs:

mA) Aggregating buyers
mB) Aggregating sellers
mC) Evaluating sellers' opportunities and creating partnerships
mD) Presenting commercial opportunities
mE) Ensuring commissions & terms with both sides
mF) Ensuring quality of experience for both sides
mG) costs of information loss to sellers
mH) costs of information loss to other markets
mI) cost of getting paid commissions

The systems and methods of the present disclosure may serve to reduce these costs, facilitating connections among parties involved in ecommerce transactions, and enabling such connections to be made automatically.

Furthermore, the systems and methods disclosed herein may serve to ensure balance, growth, and power of respective stakeholders instead of creating undue (sub)zero-sum-games between them. For example, a buyer may seek to minimize the price, a seller may seek to maximize the price, and the market may seek to maximize commissions.

Yet further, there may be repeated (sub)zero-sum games between these parties. Sellers, buyers, and marketplaces may often be seeking data about one another, and may also be trying to lock each other into exclusivities. The systems and methods of the present disclosure may help to balance these competing concerns.

To implement a market successfully, infrastructure may be created that allows connections to be formed between the parties without actually forcing any participant to expose their internal workings to any stakeholder or other market participant. This infrastructure may be referred to as the “nexus”.

In at least one embodiment, the nexus may serve to increase efficiency and reduce costs by providing automatic matching mechanisms among parties, allowing stakeholders and/or other market participants to set the parameters under which they are willing to transact without exposing such parameters to others, and further facilitating automated matching among stakeholders or market participants with complementary parameters. In at least one embodiment, such operations may be performed without exposing participants' internal workings or acceptable parameters to other market participants.

On the internet, each of the market participants may have their own platform which represents them and supports their agency. For an efficient functioning of the market, these platforms may advantageously retain privacy of their internal states. Advantageously, privacy may be technically protected from invasion, rather than attempting to regain privacy by deleting exposed information, as it is often very difficult to enforce data deletion. Without privacy, smaller participants may have no defensible advantage from large participants.

In at least one embodiment, a plug-in may connect a platform to the nexus. Such plug-ins may include, for example:
a) A c-bridge that connects to a merchant's product catalog and order management systems;
b) A p-bridge that connects to a merchant's payment processing system;
c) An interface that projects a transacting environment into the customer's internet browser or mobile devices; and/or
d) An extender that connects to the market's content and/or applications.

The platform may offer all stakeholders the opportunity to manage these plug-ins and connections. The nature of these integrations and their functionality may be unique.

To create privacy-preserving transactions between stakeholder's platforms, the concept of a “conduit” may be employed: instead of directly receiving information from one side and then passing it onto the other (“middleman”), the system may facilitate creation of a direct communication channel between the two sides (a “conduit”). A conduit may be implemented, for example, by the nexus establishing a communication channel among the participants in a manner wherein nexus itself does not possess the cryptographic key for the communication, and/or where the data being transferred bypasses the nexus.

In some embodiments, cryptographic logic may be established. Cryptographic logic may provide 3-way conduits, with specific rules about what aspects of the information are shared. In some embodiments, the nexus itself may also provide privacy.

This framework may incorporate one or more of five concepts:
1. Shop
2. Extender
3. Bridge
4. Exchange
5. Vendor Relationship Management (VRM)

The shop may be focused on minimizing the customer's costs while operating within the principles set forth above. The shop may operate between the customer's platform and the nexus. The nexus may generate additional conduits between the customer and the merchant for sensitive information. The shop itself may be a conduit between the customer and the nexus that may be invoked by the publisher. The publisher may retain a certain amount of information about the transactions taking place inside the shop. The shop may advantageously respect the customer's platform by interfacing with customer's tools instead of forcing the customer to interface with the merchant's platform.

This approach may minimize costs by providing a standardized interface for cB-cD. cA may be minimized indirectly by creating competition between markets and/or lowering the barriers to entry. Innovations to reduce cE may additionally or alternatively be developed.

The extender may be focused on minimizing the costs for markets, especially mB (by automatically indexing sellers), and/or mD-mH by automatically placing commercial offers, retaining traffic on site, ensuring an excellent quality of experience. The system may generate superior returns as a result, while leveraging conduits.

The bridge may minimize the costs for sellers from, especially sA (by easily integrating with markets), sD (by maximizing conversion rates), and/or sF (by leveraging conduits). Additionally or alternatively, sE may be mitigated by deeper integration with customer platforms. sA and sB may be further improved through the exchange.

The exchange may optimize the costs across the board, especially mA, mC, mE and mI, and/or sA-B. The exchange may include the functionality of account settlement, as well as the technology of self-enforcing contracts, allowing for parameter-based matching of participants, among other advantages.

In at least one embodiment, the system may operate in connection with a platform such as Vendor Relationship Management (VRM), which is able to manage seller relationships and access improved discounts based on reputation, and which may also contribute to cost reduction. Examples of VRM platforms include credit card companies, payments companies, and banks.

In various embodiments, the foregoing may be achieved in a wide variety of implementations within the scope of the present disclosure. According to some embodiments, a software system and method may enable an Internet sales entity, referred to herein as the “merchant,” to efficiently market and sell products and services (“products”) and/or engage in other types of transactions in cooperation with websites, apps, other online platforms, or other network sites of respective business partners, referred to herein as “media” or “publishers,” by establishing points of transaction (PoTs) within media properties. In at least one embodiment, the PoTs may be co-branded and execute a joint agreement among the stakeholders. At the same time, in at least one embodiment, the system may enable a publisher to host transactions on their own sites instead of having to redirect their audiences elsewhere.

In various embodiments, the system and method may be implemented using any or all of the following, alone or in any combination:
Software powering the interactive points of transaction (PoT) integrated as JavaScript or as an SDK;
Software executing within the publisher's content, detecting content with relevant potential transactions that can be extended with PoT technology, e.g., product or service purchases, subscriptions, account creations, by examining the keywords, images, links and video elements, typically implemented as a CMS plug-in and a JavaScript library (Extender);
Software that interfaces with the merchant's business software and system, importing offerings and business rules, synchronizing with settings, allowing the merchants to transact, and exporting transactions to the system, typically implemented as a set of plug-ins (Bridge);
Software that allows merchants or their agents (e.g., marketing agencies) to manage the PoT offerings, typically implemented as a web application (Platform);
Software that allows merchants and publishers to set up working agreements, typically implemented as a web application (Exchange); and/or
Software that executes internal logic and organizes the data orchestrating the above (the “nexus”).

In some embodiments, a computer-implemented method may be used to sell products from a merchant via a publisher website hosted by a publisher. The method may include receiving content from the publisher website, wherein the content is associated with a product, displaying the content for a user, and receiving first user input from the user indicating interest in the product. The method may further include, responsive to the first user input, receiving product information about the product from a merchant distinct from the publisher and, at the output device, without navigating away from the publisher's website, displaying the product information. Further, the method may include, without navigating away from the publisher's website, receiving second user input indicating a desire to purchase the product, and, responsive to the second user input and without navigating away from the publisher's website, transmitting an order to purchase the product to the merchant.

Displaying the product information may include displaying a transaction window containing the product information, without navigating away from the publisher's website.

Receiving the product information may include receiving the product information via a facilitator distinct from the publisher and the merchant.

Transmitting the order may include receiving the purchase order at a facilitator website operated by the facilitator, and transmitting payment information for the purchase order to the merchant such that the payment information is not stored at the facilitator website or at the merchant system after transmission of the payment confirmation information to the merchant.

The method may further include, prior to displaying the Point of Transaction, executing service agreements by the facilitator on behalf of the publisher, the merchant, the customer, and/or the facilitator. Once such service agreements have been executed, the transaction may be acceptable for all involved stakeholders. For example, a service agreement may govern how the publisher and the merchant may collaborate to sell the product. A service agreement may also define the conditions under which the customer is willing to transact (including, for example, policies governing privacy, return policy, and/or warranty).

The method may further include, prior to executing the service agreements, recruiting merchants and publishers, and/or collecting profiling information from the merchant and the publisher via an onboarding platform.

The profiling information may be manually managed, and may be automatically inferred from product information. The method may further include, prior to establishing a point of transaction, automatically evaluating the association between the content and the product, to determine if the content is suitable for association with the product and vice versa. The association may also be further informed by service agreements and/or by manual evaluation by any of the involved stakeholders.

The method may further include displaying an advertisement for the product and, responsive to third user input indicating interest in the product, displaying the point of transaction.

Displaying the content for the user may include displaying an icon and/or animation in association with the content. Receiving the first user input may include receiving user selection of the icon.

Displaying the content for the user may further include displaying the icon and/or animation superimposed on the content. In at least one embodiment, the conditions and/or manner in which the icon and/or animation are displayed may depend on user actions; for example, the icon and/or animation may be displayed after on-hover, on-touch, or after a period of constant content viewability.

In at least one embodiment, displaying the point of transaction, especially after the first engagement and before the payment confirmation, may involve security isolation from publisher's content or adversarial code placed inside the publisher's content. Examples of isolation techniques include Iframes and WebComponents.

Receiving the second user input may include receiving user selection of a purchase option displayed in the transaction window. For example, a customer may choose Apple Pay, PayPal, or a BNPL offering, or may enter a credit card number. Receiving the second user input may also include receiving additional information about the customer, which may lead to additional discounts or personalization. For example, a customer can log into an SSO system that may return a validated email address, or may sign the customer into the merchant's loyalty program.

The method may further include, prior to receiving the second user input, receiving third user input selecting the product from among a plurality of products offered for sale from within the transaction window.

The method may further include techniques of proceeding with purchases with incomplete information, wherein the remaining information for the purchase can be obtained after the purchase takes place. For example, a sale can proceed even if the payment method is incomplete, as long as it is possible to acquire the missing information afterwards. By reducing the set of information that is required pre-sale, the system is able to increase conversion rates and encourage more purchases.

The method may further include techniques of ensuring that communication with a customer can be continued without disruption. For example, the system is able to ensure that the customer's email address and/or phone number are correct, thus enabling purchases to be completed even if other information is incomplete.

In at least one embodiment, after a purchase is confirmed, two additional steps may take place: 1) the purchase process can be continued at the merchant website, leading to a larger order value without the limitations of the limited space and functionality; and 2) the system may ensure that the customer has correctly received the receipt to their chosen communication channel.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for implementing the techniques described herein according to one embodiment.

FIG. 2 is a block diagram depicting a hardware architecture for implementing the techniques described herein in a client/server environment, according to one embodiment.

FIG. 3 is a flowchart depicting a method for selling products from a merchant via a publisher website, according to one embodiment.

FIG. 4 is a block diagram depicting a system that may be used to implement the method of FIG. 3, according to one embodiment.

FIG. 5 is a block diagram depicting part of the system of FIG. 4 in greater detail, according to one embodiment.

FIG. 6 is a block diagram depicting how the c-bridge of FIG. 5 may interface with the nexus for importing offers and exporting transactions.

FIG. 7 is a block diagram depicting an exemplary architecture for the nexus and adjacent services, according to one embodiment.

FIG. 8 is a flow diagram depicting a finite state machine with different stages in the e-commerce purchase transaction process.

FIG. 9 and FIG. 10 are screenshots depicting a variety of responsive designs and a variety of designs, respectively, generated to allow for the point of transaction to function with a variety of constraints on the publisher platform.

FIG. 11 is a block diagram depicting an exemplary security model associated with the insertion of the point of transaction into the content transmitted from the publisher platform to the consumer's browser, according to one embodiment.

FIGS. 12 and 13 are screenshots depicting the platform interface used for management of product offerings, according to one embodiment.

FIG. 14 is a screenshot depicting content in the form of a picture that is being displayed for a user according to one embodiment.

FIG. 15 is a screenshot depicting content, with an expanded icon shown in response to user selection.

FIG. 16 is a screenshot depicting a transaction window, which may be displayed in response to user selection of the expanded icon.

FIG. 17 is a screenshot depicting the next stage in the transaction, after the user has selected the purchase button of FIG. 16.

FIG. 18 is a screenshot depicting the transaction window after payment has been selected and/or entered.

FIG. 19 is a block diagram depicting data that may be collected in connection with an online purchase.

FIG. 20 is a block diagram depicting flows of data between the consumer, the publisher, the merchant, and the facilitator, according to one embodiment.

FIG. 21 is a block diagram depicting a software architecture according to one embodiment.

FIG. 22 is a block diagram depicting additional details for a software architecture according to one embodiment.

FIG. 23 is a block diagram depicting a process for building a custom integration according to one embodiment.

FIG. 24 is a conceptual diagram depicting the relationship between a product and a k-shop unit, according to one embodiment.

FIG. 25 is a block diagram depicting a software architecture including components for building a custom integration according to one embodiment.

FIG. 26 is a screen shot depicting a screen for editing a product according to one embodiment.

FIG. 27 is a screen shot depicting a marketplace list according to one embodiment.

FIGS. 28 and 29 are screen shots depicting examples of a k-shop unit according to one embodiment.

FIG. 30 is a screen shot depicting a k-shop home screen according to one embodiment.

FIG. 31 is a screen shot depicting a brand/all products view according to one embodiment.

FIG. 32 is a screen shot depicting a k-shop information view according to one embodiment.

FIG. 33 is a screen shot depicting a more details view according to one embodiment.

FIG. 34 is a screen shot depicting an options view according to one embodiment.

FIG. 35 is a screen shot depicting a quantity selector according to one embodiment.

FIG. 36 is a screen shot depicting a checkout view according to one embodiment.

FIG. 37 is a screen shot depicting an order details view according to one embodiment.

FIG. 38 is a screen shot depicting a shipping address view according to one embodiment.

FIG. 39 is a screen shot depicting a shipping method view according to one embodiment.

FIG. 40 is a screen shot depicting a payment view according to one embodiment.

FIG. 41 is a screen shot depicting an order summary view according to one embodiment.

FIG. 42 is a screen shot depicting a thank you page according to one embodiment.

FIG. 43 is a diagram depicting an adaptive design according to one embodiment.

FIG. 44 is a block diagram depicting advertiser/brand flow according to one embodiment.

FIG. 45 is a block diagram depicting publisher/affiliate flow according to one embodiment.

FIG. 46A is a block diagram depicting customer flow according to one embodiment.

FIG. 46B is a block diagram depicting retailer flow according to one embodiment.

FIGS. 47A through 47D depict examples of layout customization for k-shop units, according to various embodiments.

FIG. 47E depicts an example by which embed code may be obtained to implement the approach illustrated in FIG. 47D.

### DETAILED DESCRIPTION OF THE EMBODIMENTS

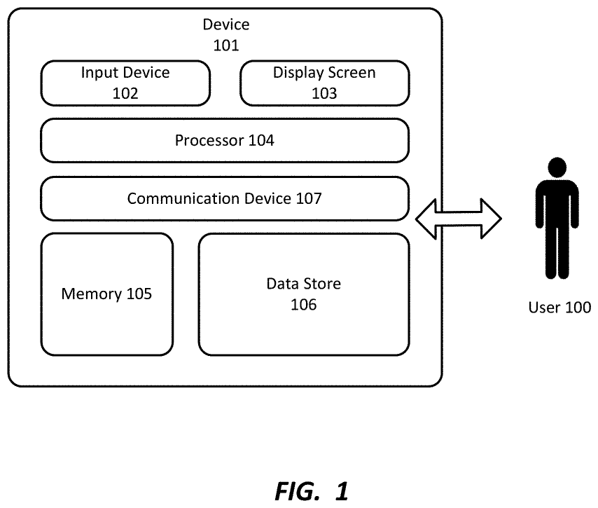

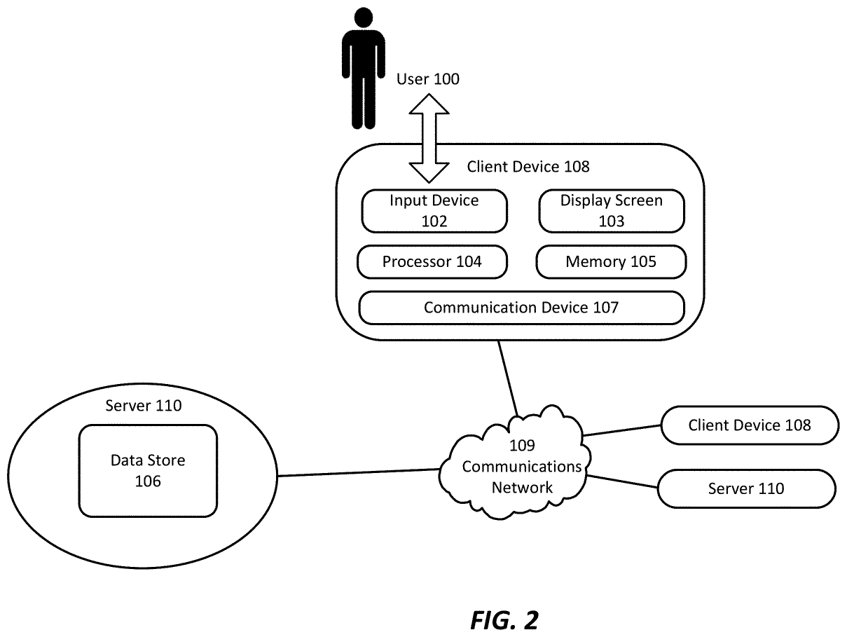

In some embodiments, one or more components, as shown and described below in connection with FIGS. 1 and 2, may be used to implement the system and method described herein. In at least one embodiment, such components may be implemented in a cloud computing-based client/server architecture, using, for example, Amazon Web Services, an on-demand cloud computing platform available from Amazon.com, Inc. of Seattle, Wash. Therefore, for illustrative purposes, the system and method are described herein in the context of such an architecture. One skilled in the art will recognize, however, that the systems and methods described herein may be implemented using other architectures, such as for example a standalone computing device rather than a client/server architecture.

Further, the functions and/or method steps set forth herein may be carried out by software running on one or more of the device 101, client device(s) 108, server(s) 110, and/or other components. This software may optionally be multi-function software that may be used to retrieve, store, manipulate, and/or otherwise use data stored in data storage devices such as data store 106, and/or to carry out one or more other functions.

### Definitions and Concepts

For purposes of the description herein, a “user”, such as user 100 referenced herein, may be an individual, enterprise, or other group, which may optionally include one or more users. A “data store”, such as data store 106 referenced herein, may be any device capable of digital data storage, including any known hardware for nonvolatile and/or volatile data storage. A collection of data stores 106 may form a “data storage system” that can be accessed by multiple users. A “computing device”, such as device 101 and/or client device(s) 108, may be any device capable of digital data processing. A “server”, such as server 110, may be a computing device that provides data storage, either via a local data store, or via connection to a remote data store. A “client device”, such as client device 108, may be an electronic device that communicates with a server, provides output to a user, and accepts input from a user.

An “entity” may be a stakeholder, merchant, brand, advertiser, publisher, affiliate, customer, bank, company, association, payment, and/or the like, or an agent for any of these.

A “product” may be any item, software, or service that can be sold online. A “merchant” may be an entity that sells one or more products online, including receiving payment and coordinating fulfillment products purchased by the user.

“Content” may be text, images, sounds, and/or video provided to a user via a computing device. A “publisher,” “affiliate”, or “media” may be an entity whose primary business is providing content to users.

A “merchant”, “advertiser”, or “brand” is an entity that owns a product. Such an entity can create its own placements (such as blogs, websites, or the like) and/or distribute such information to affiliates and/or publishers.

A “k-shop unit” is a vessel for transmitting information about a product to be advertised.

An “affiliate” or “publisher” is an entity that can embed and distribute a k-shop unit which they have received from the advertiser or brand. In at least one embodiment, affiliates or publishers may also own their own product(s), in which case they may also be considered an advertiser.

A “media agency” is an entity that does work on behalf of the brand, and creates and distributes k-shop units to its partners, which may include, for example, publishers and advertising technology (adtech) companies. In at least one embodiment, media agencies do not own a product, but may in some cases own a shop.

### System Architecture

According to various embodiments, the systems and methods described herein may be implemented on any electronic device or set of interconnected electronic devices, each equipped to receive, store, and present information. Each electronic device may be, for example, a server, desktop computer, laptop computer, smartphone, tablet computer, and/or the like. As described herein, some devices used in connection with the systems and methods described herein may be designated as client devices, which may be generally operated by end users. Other devices may be designated as servers, which generally conduct back-end operations and communicate with client devices (and/or with other servers) via a communications network such as the Internet. In at least one embodiment, the techniques described herein may be implemented in a cloud computing environment using techniques that are known to those of skill in the art.

In addition, one skilled in the art will recognize that the techniques described herein may be implemented in other contexts, and indeed in any suitable device, set of devices, or system capable of interfacing with existing enterprise data storage systems. Accordingly, the following description is intended to illustrate various embodiments by way of example, rather than to limit scope.

Referring now to FIG. 1, there is shown a block diagram depicting a hardware architecture for practicing the described system, according to one embodiment. Such an architecture may be used, for example, for implementing the techniques of the system in a computer or other device 101. Device 101 may be any electronic device.

In at least one embodiment, device 101 includes a number of hardware components that are well known to those skilled in the art. Input device 102 may be any element that receives input from user 100, including, for example, a keyboard, mouse, stylus, touch-sensitive screen (touchscreen), touchpad, trackball, accelerometer, microphone, or the like. Input may be provided via any suitable mode, including for example, one or more of: pointing, tapping, typing, dragging, and/or speech. In at least one embodiment, input device 102 may be omitted or functionally combined with one or more other components.

Data store 106 may be any magnetic, optical, or electronic storage device for data in digital form; examples include read-only memories (ROMs), random access memories (RAMs), flash memory, magnetic or solid state drives, or the like. In at least one embodiment, data store 106 stores information that may be utilized and/or displayed according to the techniques described below. Data store 106 may be implemented in a database or using any other suitable arrangement. In another embodiment, data store 106 may be stored elsewhere, and data from data store 106 may be retrieved by device 101 when needed for processing and/or presentation to user 100. Data store 106 may store one or more data sets, which may be used for a variety of purposes and may include a wide variety of files, metadata, and/or other data.

In at least one embodiment, data store 106 may store content, product information, shipping information, payment information, user preferences, and/or the like. In at least one embodiment, such data may be stored at another location, remote from device 101, and device 101 may access such data over a network, via any suitable communications protocol.

In at least one embodiment, data store 106 may be organized in a file system, using well known storage architectures and data structures, such as relational databases. Examples include MySQL and PostgreSQL. Appropriate indexing may be provided to associate data elements in data store 106 with each other. In at least one embodiment, data store 106 may be implemented using cloud-based storage architectures such as Amazon S3 and/or Cloudflare.

Data store 106 may be local or remote with respect to the other components of device 101. In at least one embodiment, device 101 may be configured to retrieve data from a remote data storage device when needed. Such communication between device 101 and other components may take place wirelessly, by Ethernet connection, via a computing network such as the Internet, via a cellular network, or by any other appropriate communication systems.

In at least one embodiment, data store 106 may be detachable in the form of a CD-ROM, DVD, flash drive, USB hard drive, and/or the like. Data store 106 may include multiple stores for redundancy, backup, sharding, and/or scalability. Information may be entered from a source outside of device 101 into a data store 106 that may be detachable, and later displayed after the data store 106 is connected to device 101. In another embodiment, data store 106 may be fixed within device 101.

In at least one embodiment, data store 106 may be organized into one or more well-ordered data sets, with one or more data entries in each set. Data store 106, however, may have any suitable structure. Accordingly, the particular organization of data store 106 need not resemble the form in which information from data store 106 is displayed to user 100 on display screen 103. In at least one embodiment, an identifying label may also be stored along with each data entry, to be displayed along with each data entry.

Display screen 103 may be any element that displays information such as text and/or graphical elements. In particular, display screen 103 may present a user interface for entering, viewing, configuring, selecting, editing, and/or otherwise interacting with transactions as described herein. In at least one embodiment where only some of the desired output may be presented at a time, a dynamic control, such as a scrolling mechanism, may be available via input device 102 to change which information is currently displayed, and/or to alter the manner in which the information is displayed.

Processor 104 may be a conventional microprocessor for performing operations on data under the direction of software, according to well-known techniques. Memory 105 may be random-access memory, having a structure and architecture as are known in the art, for use by processor 104 in the course of running software.

A communication device 107 may communicate with other computing devices through the use of any known wired and/or wireless protocol(s). For example, communication device 107 may be a network interface card (“NIC”) capable of Ethernet communications and/or a wireless networking card capable of communicating wirelessly over any applicable standards such as, for example, IEEE 802.11. Communication device 107 may be capable of transmitting and/or receiving signals to transfer data and/or initiate various processes within and/or outside device 101.

Referring now to FIG. 2, there is shown a block diagram depicting a hardware architecture in a client/server environment, according to one embodiment. Such an implementation may use a “black box” approach, whereby data storage and processing may be done completely independently from user input/output. An example of such a client/server environment may be a webbased implementation, wherein client device 108 runs a browser that provides a user interface for interacting with web pages and/or other web-based resources from server 110. Items from data store 106 may be presented as part of such web pages and/or other web-based resources, using known protocols and languages such as Hypertext Markup Language (HTML), Cascading Style Sheets (CSS), JavaScript, WebAssembly (Wasm), and/or the like.

Client device 108 may be any electronic device incorporating input device 102 and/or display screen 103, such as a desktop computer, laptop computer, cellular telephone, smartphone, handheld computer, tablet computer, kiosk, connected television, game system, wearable device, or the like. Any suitable type of communications network 109, such as the Internet, may be used as the mechanism for transmitting data between client device 108 and server 110, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol Secure (HTTPS), Transmission Control Protocol/Internet Protocol (TCP/IP), and/or the like, and/or any combination thereof. In at least one embodiment, client device 108 transmits requests for data via communications network 109, and receives responses from server 110 containing the requested data. Such requests may be sent via HTTP as remote procedure calls or the like.

In one implementation, server 110 may be responsible for data storage and processing, and incorporates data store 106. Server 110 may include additional components as needed for retrieving data from data store 106 in response to requests from client device 108.

As described above in connection with FIG. 1, data store 106 may be organized into one or more well-ordered data sets, with one or more data entries in each set. Data store 106, however, may have any suitable structure, and may store data according to any organization system known in the information storage arts, such as databases and other suitable data storage structures. As in FIG. 1, data store 106 may store content, product information, shipping information, payment information, user preferences, and/or the like; alternatively, such data may be stored elsewhere (such as at another server) and retrieved as needed.

In addition to or in the alternative to the foregoing, data may also be stored in a data store 106 that may be part of client device 108. In some embodiments, such data may include elements distributed between server 110 and client device 108 and/or other computing devices in order to facilitate secure and/or effective communication between these computing devices.

As discussed above in connection with FIG. 1, display screen 103 may be any element that displays information such as text and/or graphical elements. Various user interface elements, dynamic controls, and/or the like may be used in connection with display screen 103.

As discussed above in connection with FIG. 1, processor 104 may be a conventional microprocessor for use in an electronic device to perform operations on data under the direction of software, according to well-known techniques. Memory 105 may be random-access memory, having a structure and architecture as are known in the art, for use by processor 104 in the course of running software. A communication device 107 may communicate with other computing devices through the use of any known wired and/or wireless protocol(s), as discussed above in connection with FIG. 1.

In one embodiment, some or all of the system may be implemented as software written in any suitable computer programming language, whether in a standalone or client/server architecture. Alternatively, some or all of the system may be implemented and/or embedded in hardware.

Notably, multiple client devices 108 and/or multiple servers 110 may be networked together, and each may have a structure similar to those of client device 108 and server 110 that are illustrated in FIG. 2. The data structures and/or computing instructions used in the performance of methods described herein may be distributed among any number of client devices 108 and/or servers 110. As used herein, “system” may refer to any of the components, or any collection of components, from FIGS. 1 and/or 2, and may include additional components not specifically described in connection with FIGS. 1 and 2.

In some embodiments, data within data store 106 may be distributed among multiple physical servers. Thus, data store 106 may represent one or more physical storage locations, which may communicate with each other via the communications network and/or one or more other networks (not shown). In addition, server 110 as depicted in FIG. 2 may represent one or more physical servers, which may communicate with each other via communications network 109 and/or one or more other networks (not shown).

In at least one embodiment, some or all components of the system may be implemented in software written in any suitable computer programming language, whether in a standalone or client/server architecture. Alternatively, some or all components may be implemented and/or embedded in hardware.

### Overview

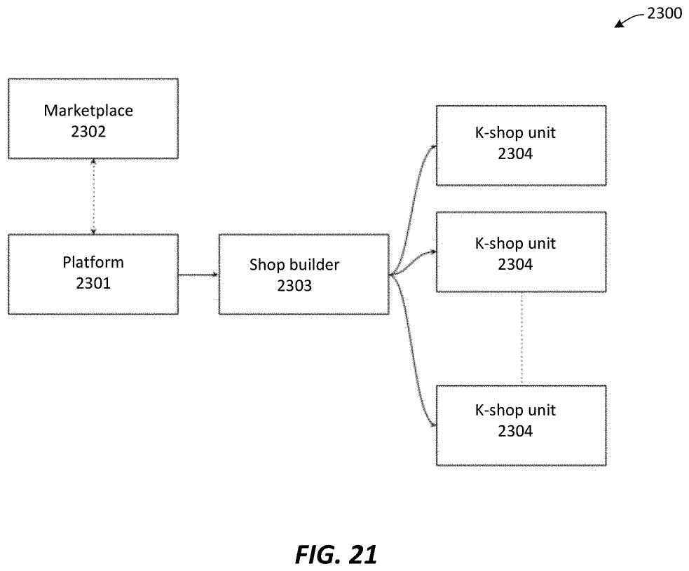

Referring now to FIG. 21, there is shown a block diagram depicting a software architecture according to one embodiment.

In at least one embodiment, the system may include four components, which may be implemented as software components running on the hardware depicted in FIG. 1 and/or FIG. 2. One skilled in the art will recognize that the software components may be implemented on hardware other than that depicted in FIG. 1 and/or FIG. 2. The four components may include:
Platform 2301;
Marketplace 2302;
Shop builder 2303; and
K-shop unit(s) 2304 (or shop(s)).

In at least one embodiment, a product may be owned by the advertiser or merchant. A product may have attributes such as price, description, images, options, variants, and/or the like.

In at least one embodiment, a product may be made shoppable by wrapping it into a k-shop unit 2304, which provides the product with transacting capabilities.

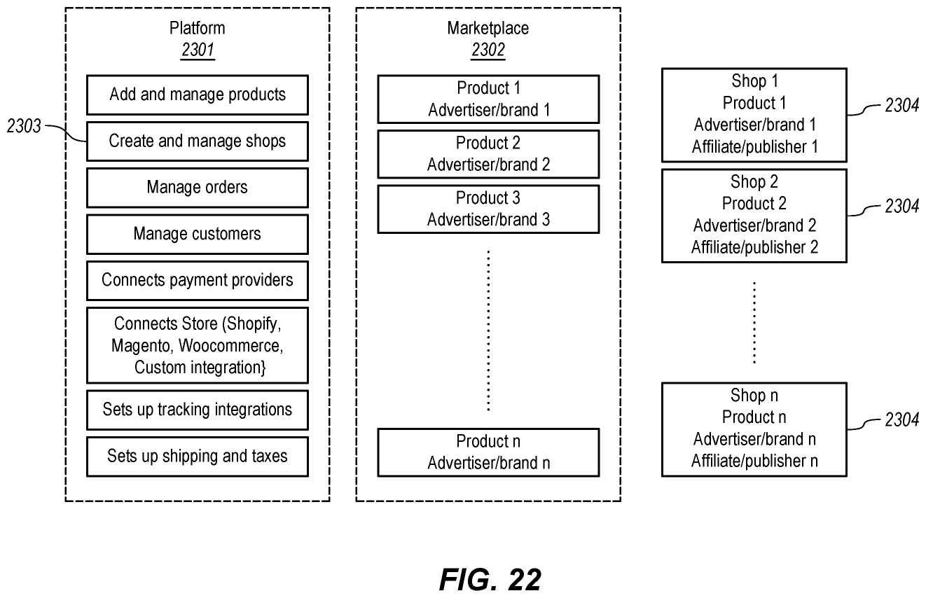

Referring now to FIG. 22, there is shown a block diagram depicting additional details for the software architecture of FIG. 21, according to one embodiment.

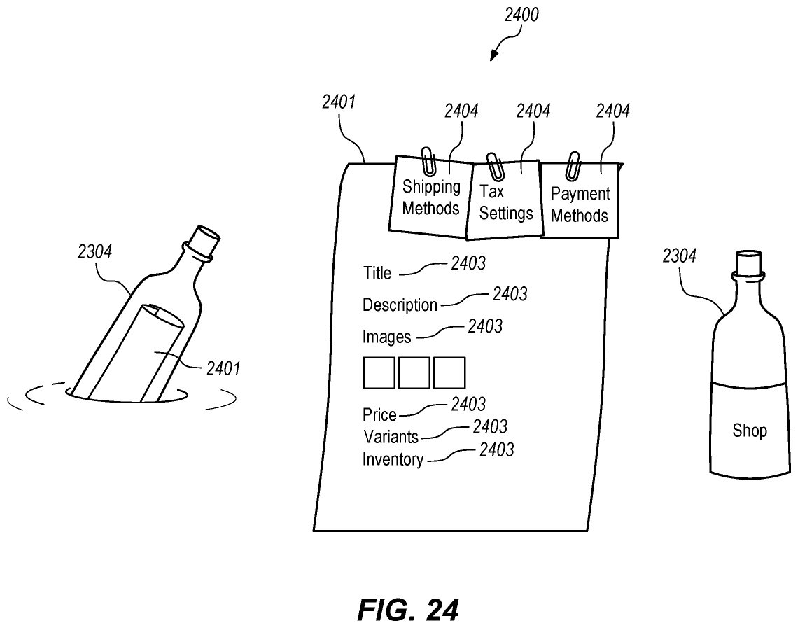

Referring now to FIG. 24, there is shown a conceptual diagram 2403 depicting the relationship between a product 2401 and a k-shop unit 2304 (also referred to as a “shop”), according to one embodiment.

Product 2401 is owned by the advertiser and/or brand. Product 2401 may have various attributes 2403 including, for example, title, description, product images, price, variants, inventory, and/or the like. Attached to product 2401 may be various global settings 2404 such as payment methods, tax methods, and/or shipping methods. In at least one embodiment, such global settings 2404 may apply to all products 2401 the brand has listed within the platform.

In at least one embodiment, each k-shop unit 2304 acts as a vessel (depicted in FIG. 24 as a bottle), which may be labeled and/or customized as needed and/or appropriate. In at least one embodiment, such labeling and/or customization of k-shop unit 2304 does not change or affect the content of k-shop unit 2403, specifically product 2401, since product 2401 belongs to the advertiser/brand. Once configured and customized, k-shop unit 2403 may enable product(s) 2401 to be placed anywhere.

In at least one embodiment, each k-shop unit 2304 may be an adaptive vessel that carries products with all their attributes, providing such products with transacting capabilities, and providing the ability to morph into any screen and populate any kind of real estate depending on the intent of use, including for example programmatic ads, videos, pop-ups, side trays, images, links, and/or the like.

K-shop units 2304 may be product displays as well as fully functional and interactive portable units that users may use to engage and inform themselves about products, select various options, quantity, payment options, delivery options and/or the like, and complete their purchases at the point of discovery.

K-shop units 2304 may be owned by the advertiser/brand or by the affiliate/publisher:

### Platform 2301

In at least one embodiment, platform 2301 may be used by advertisers/brands and affiliates/publishers to add and manage products 2401, manage integrations and connected stores, and manage payments, orders, customers, and/or organization members. Platform 2301 may also be used to track integrations, and may be used for creation of k-shop units 2304.

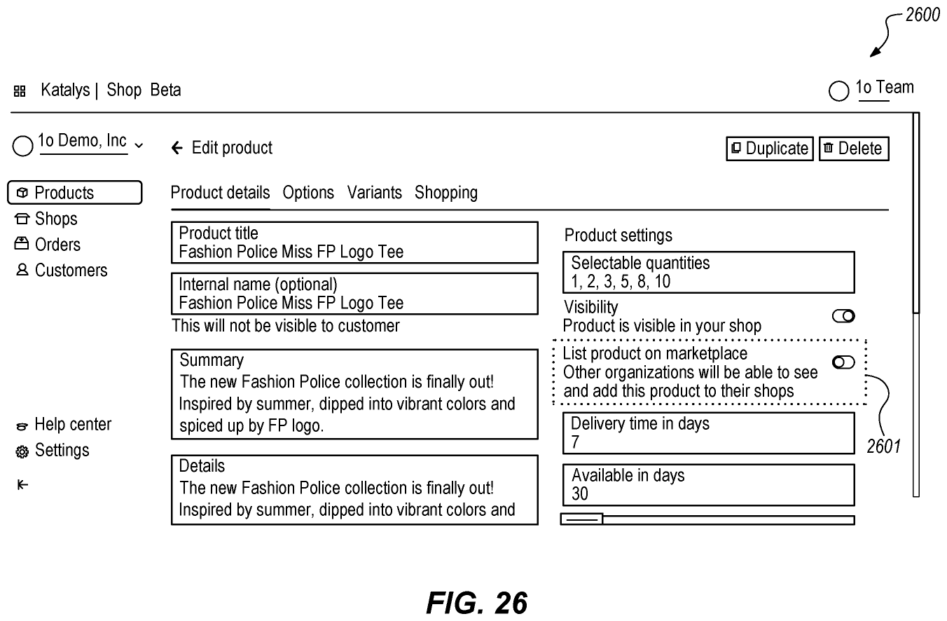

FIG. 26 is a screen shot 2600 depicting a screen for editing a product according to one embodiment. A toggle 2601 is provided to select whether or not a product is to be listed on the marketplace 2302.

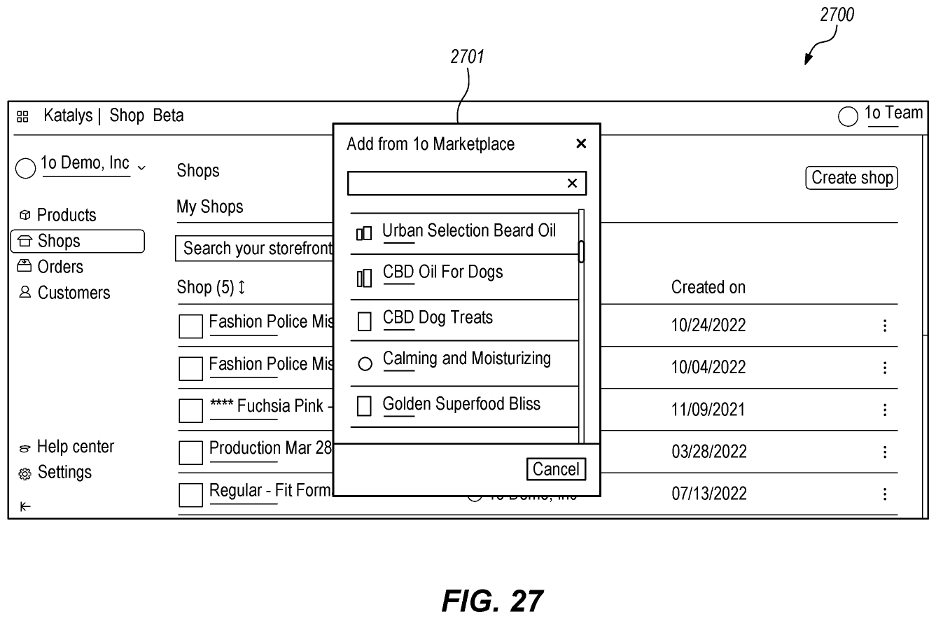

FIG. 27 is a screen shot 2700 depicting a marketplace list 2701 according to one embodiment. Products may be selected from the marketplace list 2701 to be listed on the marketplace 2302.

### Marketplace 2302

In at least one embodiment, advertisers/brands may be able to list their products 2401 on marketplace 2302. Once a product 2401 is added to the platform, advertisers/brands can choose the product 2401 to be visible to other organizations within the network. This allows other organizations, such as affiliates and/or publishers, to create k-shop units 2304 by adding products 2401 listed on the network without having to own or add their own products to the platform. K-shop units 2304 created with products 2401 from marketplace 2302 may be branded with affiliate/publisher branding while the products 2401 are still owned by the advertiser, who may process and fulfill orders directly.

### K-Shop Unit(s) 2304

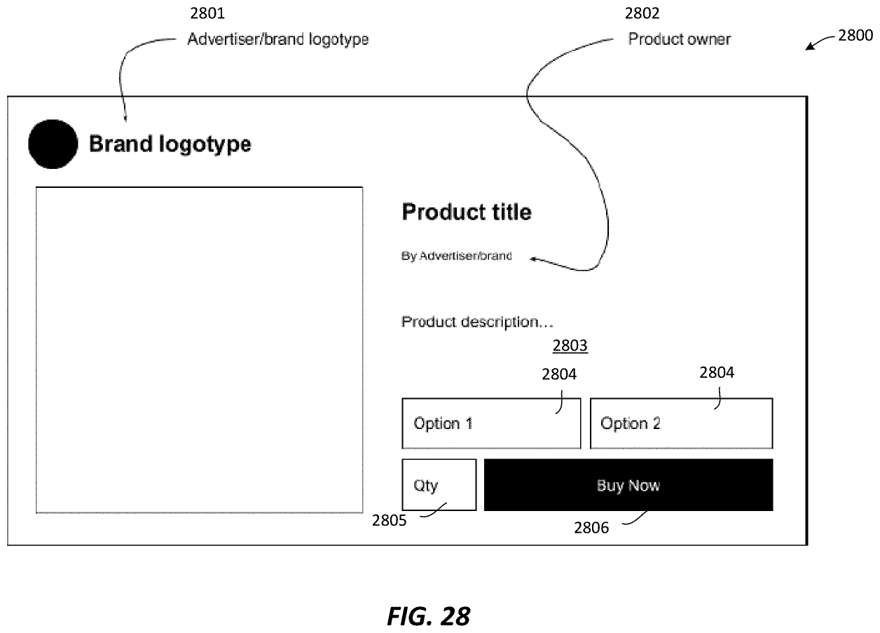

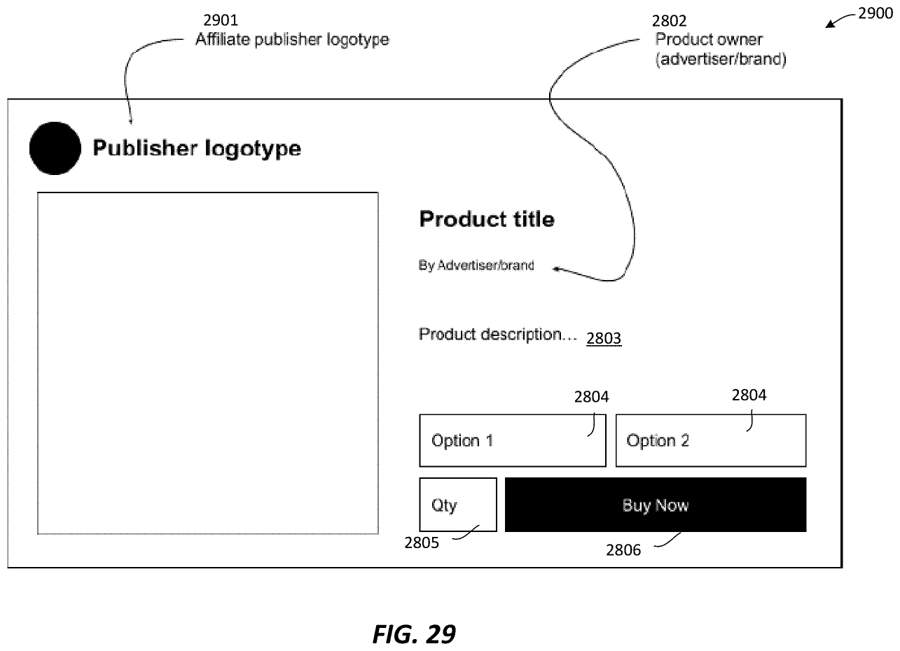

FIGS. 28 and 29 are screen shots depicting examples 2800, 2900 of a k-shop unit 2304 according to one embodiment. As shown in FIG. 28, an advertiser/brand logo 2801 may be included, along with a product owner 2802, product description 2803, options 2804, quantity 2805, and buy now button 2806. In FIG. 29, an affiliate publisher logo 2901 is included.

### Shop Builder 2303

In at least one embodiment, shop builder 2303 may be used to create any number of k-shop units 2304 from a single product. Advertisers, affiliates, and/or other users may use shop builder 2303 to customize shops to fit branding needs and to accommodate specific sizes or uses.

### Adaptive Design

In at least one embodiment, the system may be able to automatically resize (or “morph”) k-shop units 2304 as needed to fit different window sizes, aspect ratios, and shapes, while maintaining the same functionality. In at least one embodiment, such morphing can take place dynamically, for example in response to a user resizing a window on a screen. In at least one embodiment, some elements of a k-shop unit 2304 may be resized, reconfigured, abbreviated, expanded, and/or omitted, depending on current window size, aspect ratio, and shape.

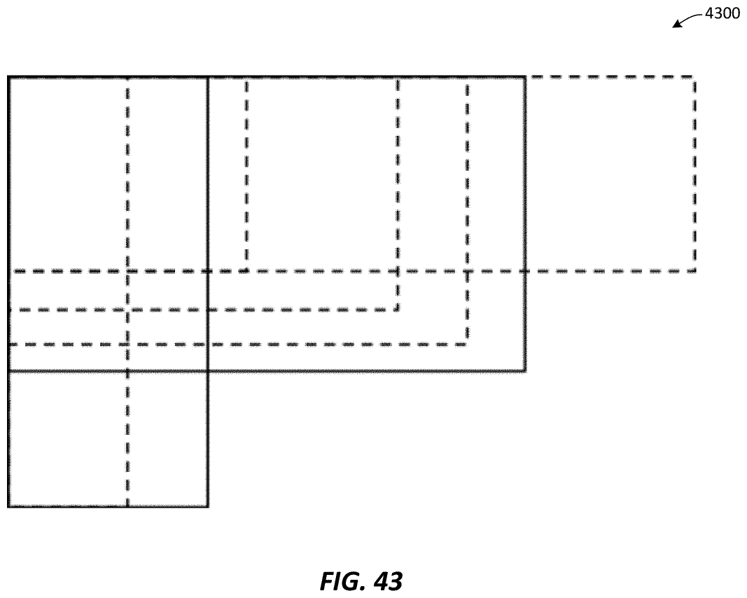

FIG. 43 is a diagram depicting an adaptive design 4200 including various potential window sizes and shapes, according to one embodiment.

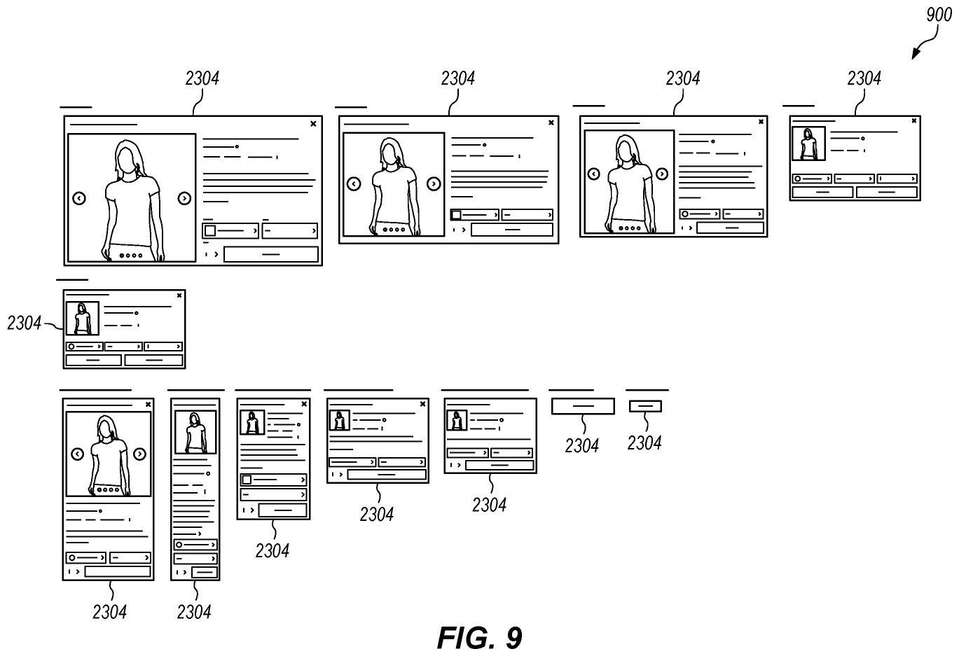

Referring again to FIG. 9, there are shown examples 900 of application of adaptive design according to one embodiment, wherein a k-shop unit 2304 may be displayed in various sizes, layouts, and formats depending on current window size and shape.

### Layout Customization

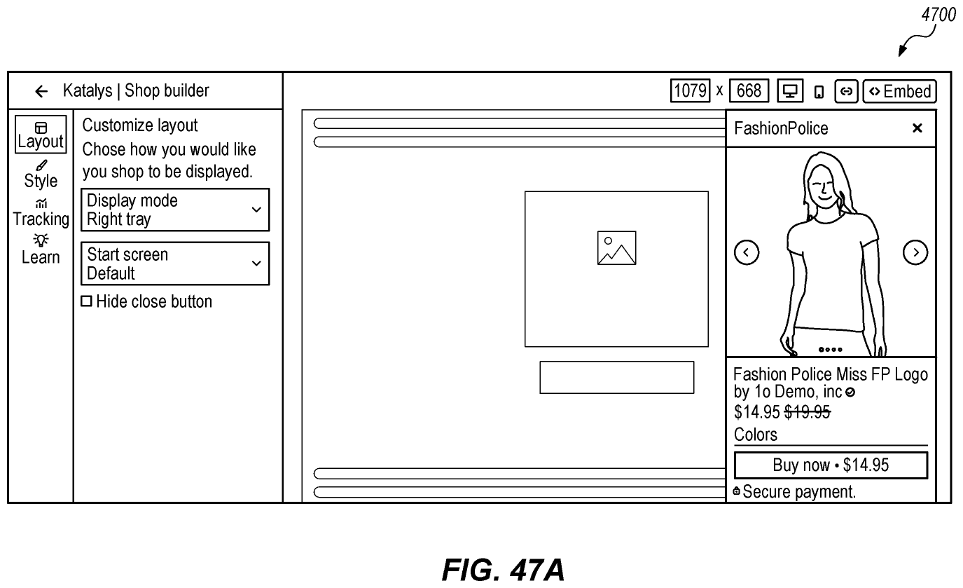

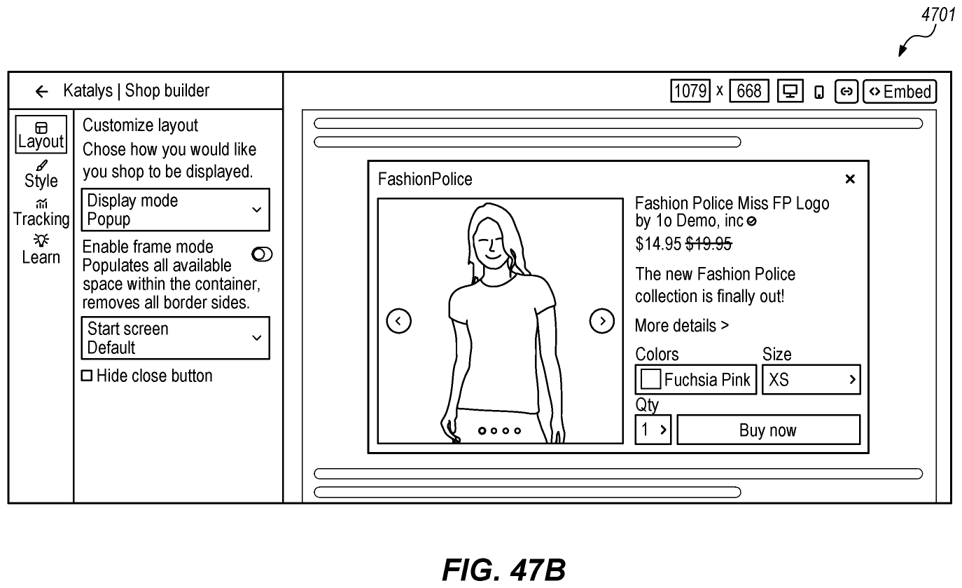

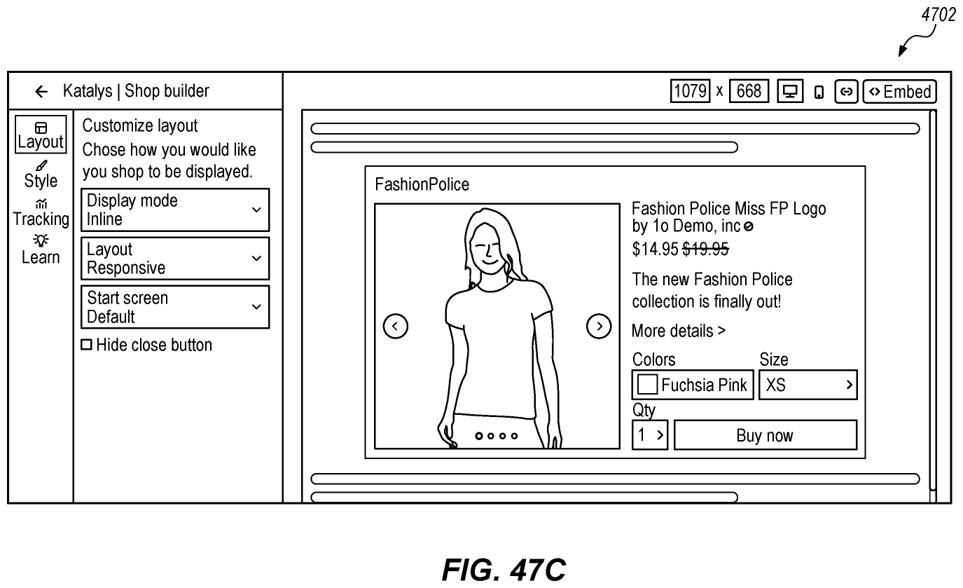

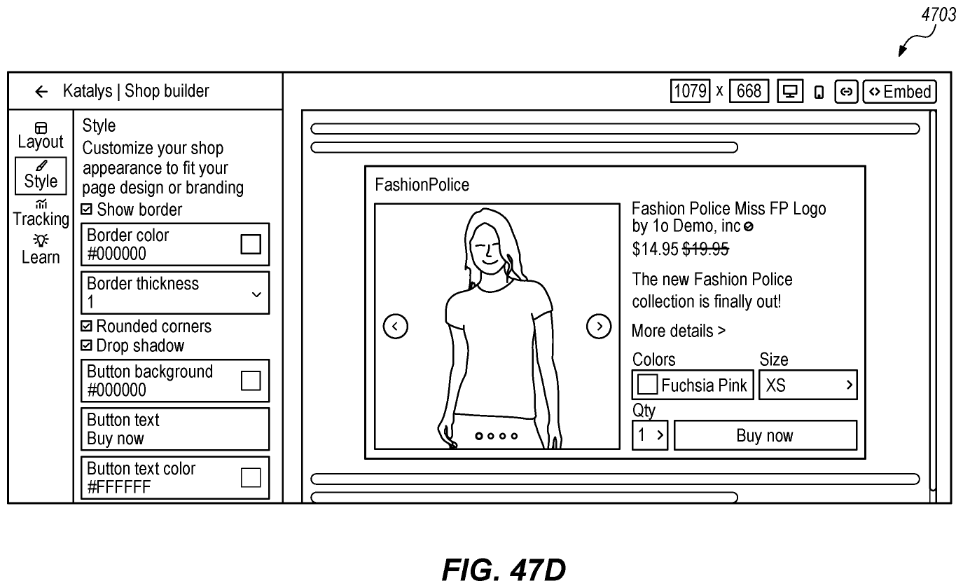

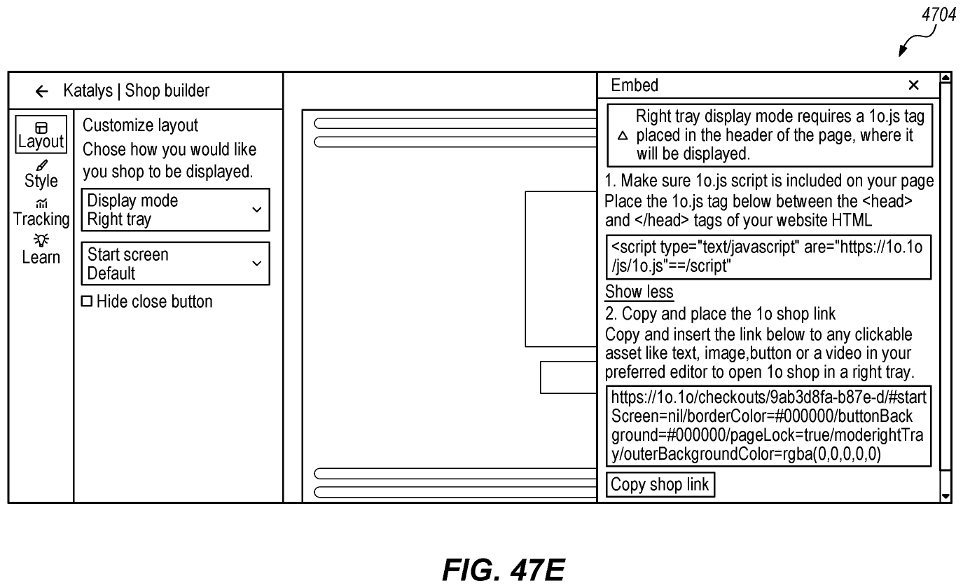

Any of a number of approaches can be used for embedding k-shop units 2304. FIGS. 47A through 47D depict four examples, although one skilled in the art will recognize that other mechanisms may be used.

FIG. 47A depicts an example of a right tray approach 4700, wherein k-shop unit 2304 may be displayed over content within a drawer that slides in from the left-hand side.

FIG. 47B depicts an example of a pop-up approach 4701, wherein k-shop unit 2304 may be displayed over content within a pop-up lightbox.

FIG. 47C depicts an example of an inline approach 4702, wherein k-shop unit 2304 may be displayed as an embedded widget inside displayed content.

FIG. 47D depicts an example of an embedded approach 4703, wherein k-shop unit 2304 may be embedded within an advertisement, and wherein k-shop unit 2304 may be configured to better fit the content.

FIG. 47E depicts an example by which embed code 4704 may be obtained to implement approach 4703 of FIG. 47D.

### Advertiser/Brand Shop Creation Flow

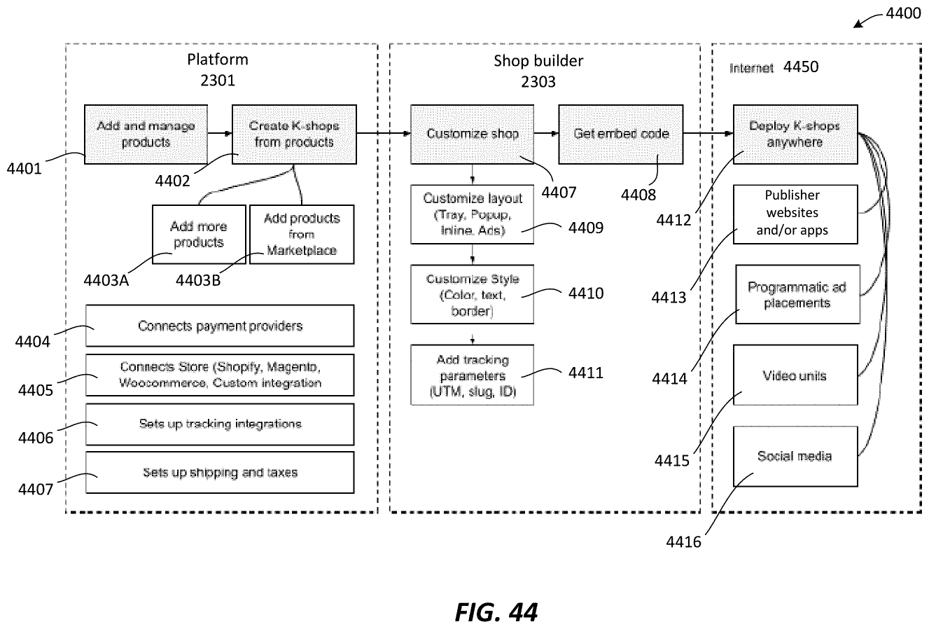

FIG. 44 is a block diagram depicting advertiser/brand flow 4400 according to one embodiment, including functionality available in various components of the system according to one embodiment.

In at least one embodiment, platform 2301 may enable functionality for performing the following:
adding and managing products 4401;
creating 4402 k-shop units 2304 from products;
adding additional products 4403A;
adding products from a marketplace 4403B;
connecting payment providers 4404;
connecting to a store 4405;
setting up tracking integrations 4406; and
setting up shipping and tax options 4407.

In at least one embodiment, shop builder 2303 may enable functionality for performing the following:
customizing 4407 k-shop unit(s) 2304;
obtaining embed code 4408;
customizing layout 4409;
customizing style 4410; and
adding tracking parameters 4411.

Once k-shop unit(s) 2304 have been created and configured, they may be deployed 4412 in any suitable location on the Internet 4450, such as for example:
publisher websites and/or apps 4413;
programmatic ad placements 4414;
video units 4415; and/or
social media 4416.

### Publisher/Affiliate Flow

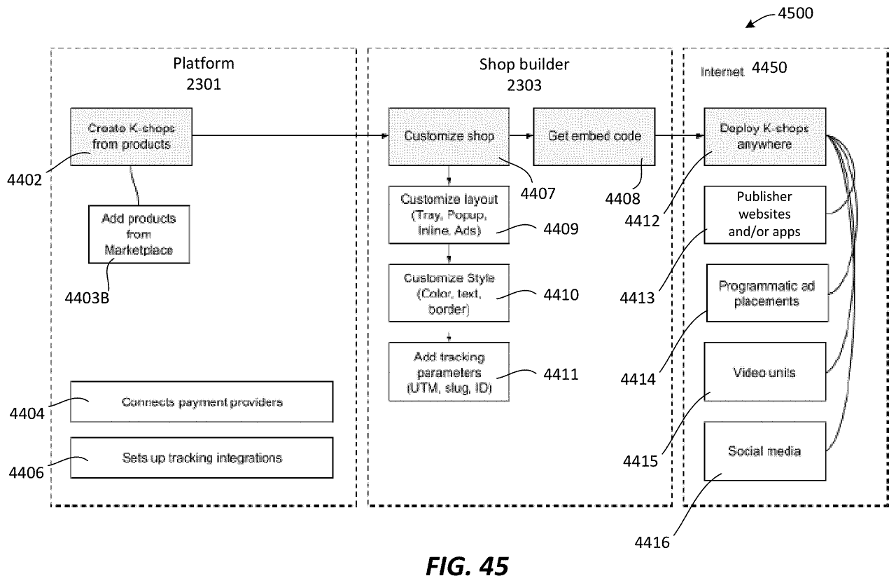

FIG. 45 is a block diagram depicting publisher/affiliate flow 4500 according to one embodiment, including functionality available in various components of the system according to one embodiment.

In at least one embodiment, a publisher/affiliate may receive ready-made k-shop unit(s) 2304 from the advertiser/brand to embed them into their content for distribution. In this case, the k-shop unit(s) 2304 may be branded with advertiser/affiliate branding. Such an approach does not require the publisher/affiliate to onboard on the platform.

Alternatively, in at least one embodiment, a publisher/affiliate may create and customize their own k-shop unit(s) 2304 from the products available at marketplace 2302. In at least one embodiment, a publisher/affiliate may be onboarded as an organization on the platform to enable such functionality.

### Customer Flow

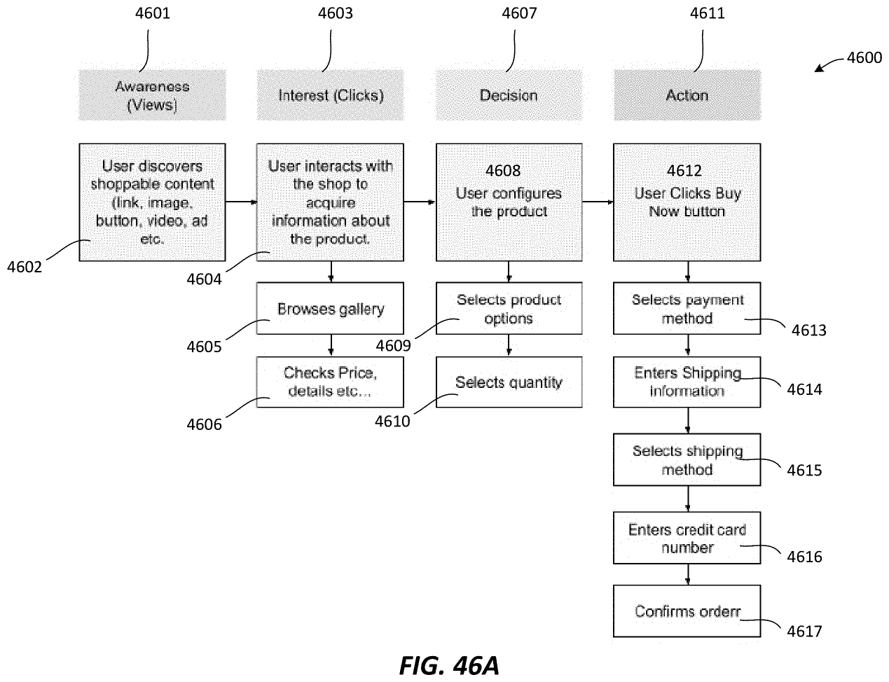

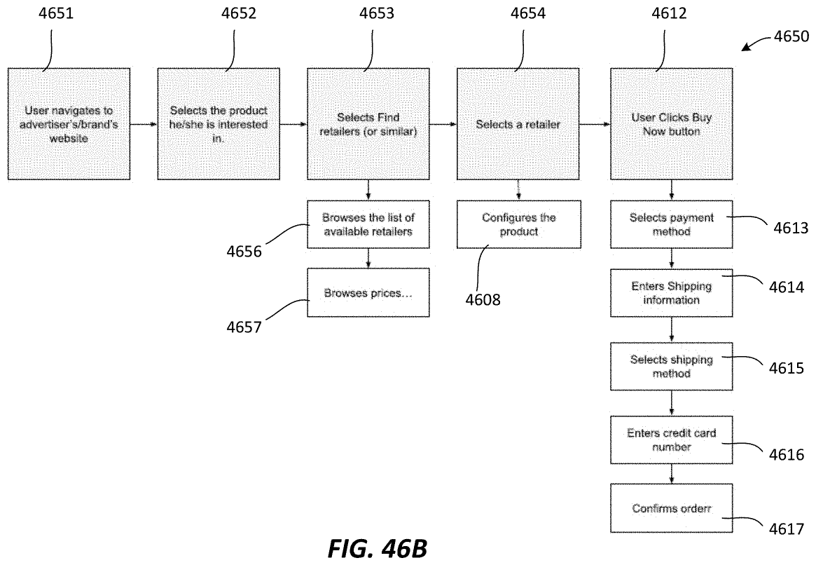

FIG. 46A is a block diagram depicting customer flow 4600 according to one embodiment.

The first column refers to awareness (views) 4601. A user may discover 4602 shoppable content, such as a link, image, button, video, advertisement, and/or the like.

The second column refers to interest (clicks) 4603. A user may interact 4604 with a k-shop unit 2304 to acquire information about a product in which they are interested. This may include, for example, browsing a gallery 4605, checking price details 4606, and/or the like.

The third column refers to a purchase decision 4604. A user may configure the product 4608. This may include, for example, selecting product options 4609, selecting quantity 4610, and/or the like.

The fourth column refers to a purchase action 4605. A user may click a Buy Now button 4612. In the course of purchasing the product, the user, for example, select a payment method 4613, enter shipping information 4614, select a shipping method 4615, enter a credit card number 4616, and confirm the order 4617.

### Retailer Flow

In at least one embodiment, an advertiser/brand may not sell directly to customers (D2C) but may use a network of partners and/or retailers. The techniques described herein enable customers to purchase products directly on advertisers'/brands' websites from their authorized retailers/resellers without ever having to leave the page.

FIG. 46B is a block diagram depicting retailer flow 4650 according to one embodiment.

A user may navigate to an advertiser's/brand's website 4651. The user may select the product they are interested in 4652. The user may initiate a search for retailers 4653, and may browse the list of available retailers 4656 and prices 4657.

The user may select a retailer 4654 and configure the product 4608.

The user may then click a Buy Now button 4612, as described above in connection with FIG. 46A.

### Building Custom Integration

In at least one embodiment, platform 2301 accesses the merchant's (brand's/advertiser's) eCommerce system's product database through a bridge. Accordingly, the merchant may have an endpoint that can receive events from platform 2301, such as user 100 actions.

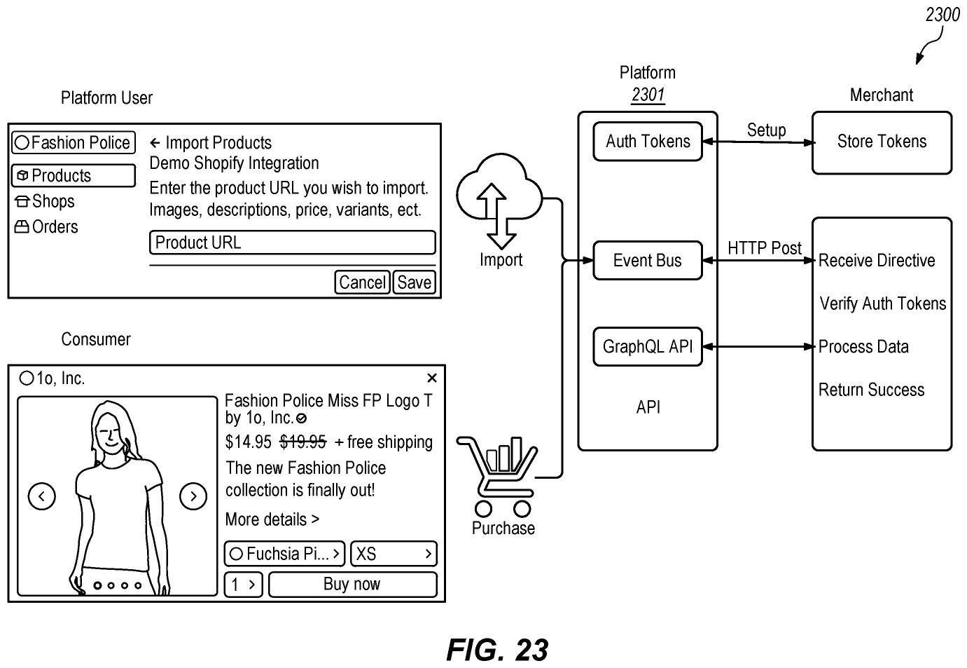

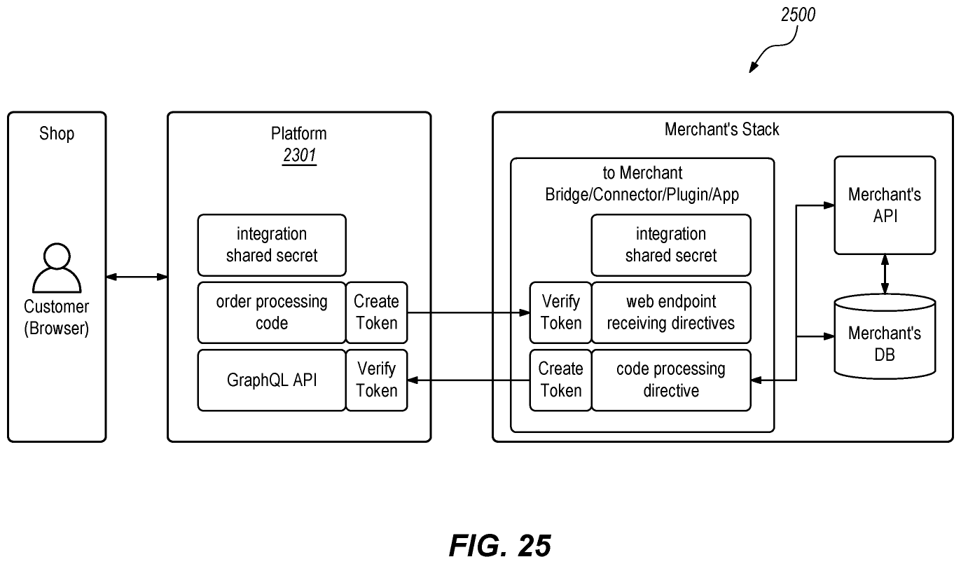

FIG. 23 is a block diagram depicting a process 2300 for building a custom integration according to one embodiment, and depicts the interaction between platform 2301 and a merchant. FIG. 25 is a block diagram depicting a software architecture 2500 including components for building a custom integration according to one embodiment.

Method of Selling Products from a Merchant via a Publisher Website

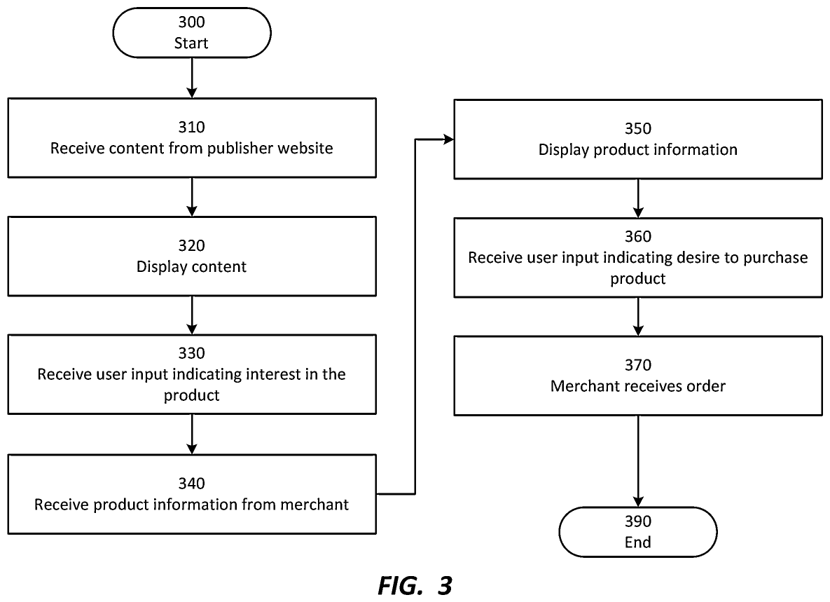

FIG. 3 is a flowchart depicting a method for selling products from a merchant via a publisher website, according to one embodiment. As shown, the method may start 300 with a step 310 in which content may be received from a publisher's website, for example, in a device 101 associated with a user 100 such as a consumer interested in viewing and/or listening to the content. In a step 320, the content may be displayed for the user 100 on the display screen 103. Step 320 may include displaying a web page forming part of the publisher's website, for example within a window of a browser running on device 101 or client device 108. Furthermore, in step 320, an icon or animation may be displayed to communicate to the user 100 that access to the product information and/or purchasing is easily accessible.

In a step 330, user input may be received, indicating that the user 100 may be interested in a product associated with the content. In a step 340, product information may be received from the merchant in response to the user input. The information may be received, for example, via a website operated by the merchant, or from a facilitator's database. The merchant may be independent of the publisher; i.e., a person or entity that is not under common control with the publisher. In some cases, the product information may have been already pre-loaded prior to step 340 to allow for immediate display and a superior user experience. In a step 350, the product information may be displayed for the user 100.

In a step 360, user input may be received, indicating that the user 100 wants to purchase the product. In a step 370, a purchase order may be received by or transmitted to the merchant, for example, via the merchant's website or API. The method may then end 390.

In this disclosure, a “purchase” includes not only the exchange of goods for money, but also the exchange of services or information, regardless of whether the user 100 spends money on the purchase. For example, a “purchase” may be ordering promotional product, subscribing to a newsletter, or adding an item to a wish list, in each case at no charge.

Advantageously, one or more of the step 330, the step 340, the step 350, the step 360, and the step 370 may be performed without navigating away from the publisher's website at which the content is hosted. Thus, the user 100 may remain engaged with the publisher's website during the purchase process. In at least one embodiment, one or more of the step 330, the step 340, the step 350, the step 360, and the step 370 may be performed without navigating away from the web page displayed in step 320.

eCommerce Systems

In at least one embodiment, the system integrates with multiple stakeholders' platforms.

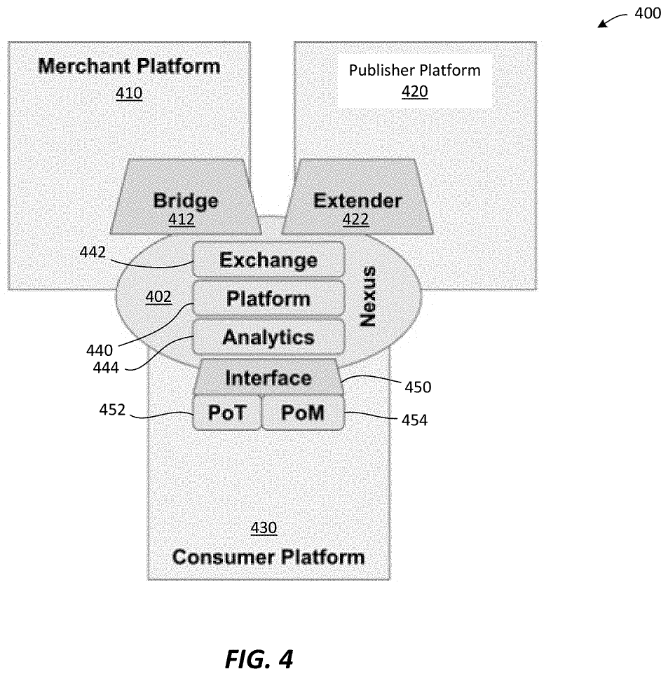

FIG. 4 depicts a system 400 that may be used to implement the method of FIG. 3, according to one embodiment. The depicted system is merely exemplary. The method of FIG. 3 may be implemented with different systems from the system 400. Further, the system 400 may be used to carry out methods different from that of FIG. 3. In at least one embodiment, the system depicted in FIG. 4 may be implemented on hardware such as that depicted in FIGS. 1 and/or 2; alternatively, it may be implemented on other hardware.

The system 400 may include a core, or nexus 402, and/or various adapters that may integrate with respective platforms, such as a bridge 412 that may integrate with a merchant platform (such as Shopify, Magento, WooCommerce, or the like) 410, an extender 422 that may integrate with a media/publisher platform (CMS) 420, and/or an interface 432 that may integrate with a consumer platform (payment method such as PayPal, Google Pay, Apple Pay, or the like) 430.

More particularly, the bridge 412 may serve to interface the nexus 402 with the merchant's business operations. The extender 422 may serve to interface the nexus 402 with the content and data on the publisher platform 420, allowing an association between relevant transactions in the nexus 402 with the content provided on the publisher platform 420, but also allowing the publisher platform 420 to leverage up-to-date information from the nexus 402.

The application interfaces to the nexus may also include, for example:
Platform 440: an application interface allowing stakeholders (including, for example, media and/or merchant stakeholders) to create, administrate, and/or annotate information about transaction offers.
Exchange 442: a software system and/or an application interface allowing stakeholders (including, for example, media and/or merchant stakeholders) to find one another and/or to establish agreements with one another.
Analytics 444: an application interface allowing stakeholders to track the effectiveness and business performance of points of transaction (PoTs).

An interface 450 may connect the nexus 402 to both a PoT 452 (point of transaction) and a PoM 454 (point of management). In at least one embodiment, the PoT 452 may be implemented as a software system and/or an application interface that allows consumers (users 100) to examine offers, configure and agree to them, and execute payments, authorizations or other requirements for a successful transaction. The PoM 454 may help consumers manage their transactions when an additional level of redundancy may be needed beyond what the merchant platform 410 offers to consumers, and/or to manage their personal data sharing beyond what is afforded by the consumer payment systems.

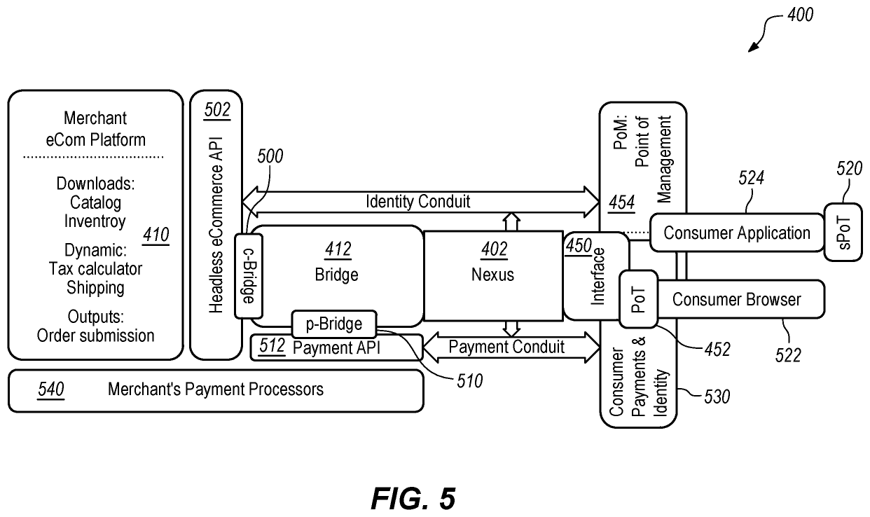

FIG. 5 is a block diagram depicting part of the system 400 of FIG. 4 in greater detail, according to one embodiment. FIG. 5 further depicts how the bridge 412 interfaces with the merchant platform 410 and/or payment processors 540. The bridge 412 may incorporate a c-bridge 500 (i.e., e-commerce bridge) that interfaces with a headless e-commerce API 502, and a p-bridge 510 (i.e., payment bridge) that interfaces with a payment API 512.

In at least one embodiment, the c-bridge 500 may be implemented for a specific platform (such as Shopify, WooCommerce, Magento, or the like), so that the bridge 412 itself can be coherent and compact. The c-bridge 500 may interface with the merchant platform 410 in a manner similar to that in which a mobile shopping application or a retail site would. In some embodiments, not all potential transactions on the merchant platform 410 may be compatible with the nexus 402.

Similarly, the p-bridge may abstract the specifics and the complexity of the merchant's payment processing from the nexus 402. Any number of different payment gateways may be supported, and they may share some specifics that the bridge 412 and nexus 402 can support.

The interface 450 may serve as a technical connection between the PoT 452 that runs within a consumer's internet browser. It may serve to protect the inner workings of the nexus 402 from a potentially compromised and insecure browser. Moreover, the interface 450 may allow an alternative application trusted by the consumer (or an SDK) to implement transactions through one or more secondary Points of Transaction (sPoT 520). Examples of a sPoT 520 include a third party shopping application, or a consumer platform such as Meta/Facebook or Google that holds a consumer's information on record and that does not permit external code to be executed within their environment.

Since internet browsers (consumer browsers 522) or consumer applications 524 can be compromised, the interface 450 may also interface with the consumer's payments and identity platforms 530 such as wallets, email addresses, telephone numbers, and/or the like. In cases where a particular payment or identity platform does not support all the necessary capabilities, or when the merchant may not be providing this capability, the consumer can leverage the interface 450 as a software application to allow them to review, modify, and manage transactions and/or seek support.

One feature of this architecture may be the presence of a payment and identity conduit: instead of the nexus 402 logging such private and sensitive information, conduits may be created between the platforms for specific authorizations and/or authentications. As such, adequate interoperability can be provided without requiring trust from either side.

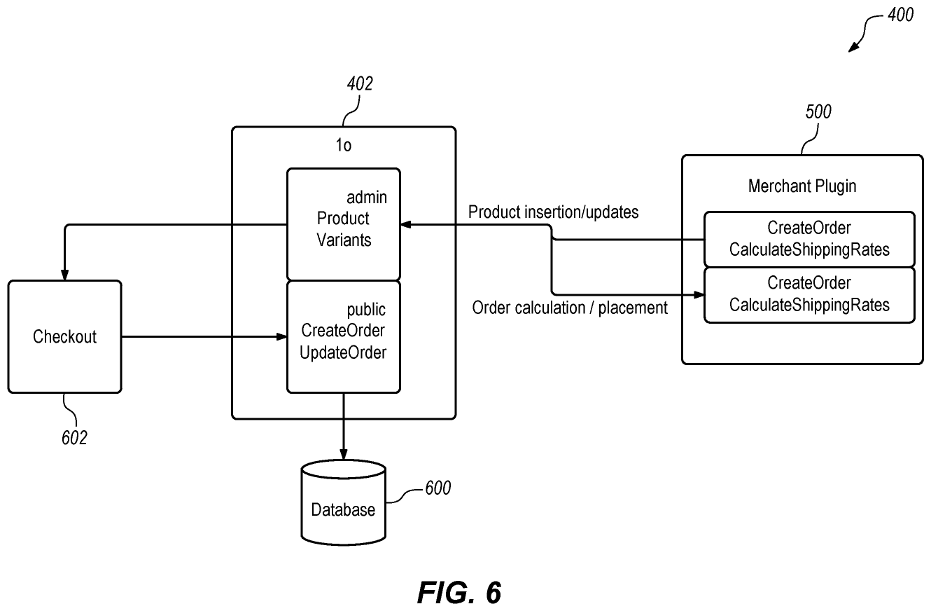

FIG. 6 is a block diagram depicting how the c-bridge 500 may interface with the nexus 402 for importing offers and exporting transactions. The nexus 402 may store transaction data and the like in a database 600, and may utilize a checkout interface 602.

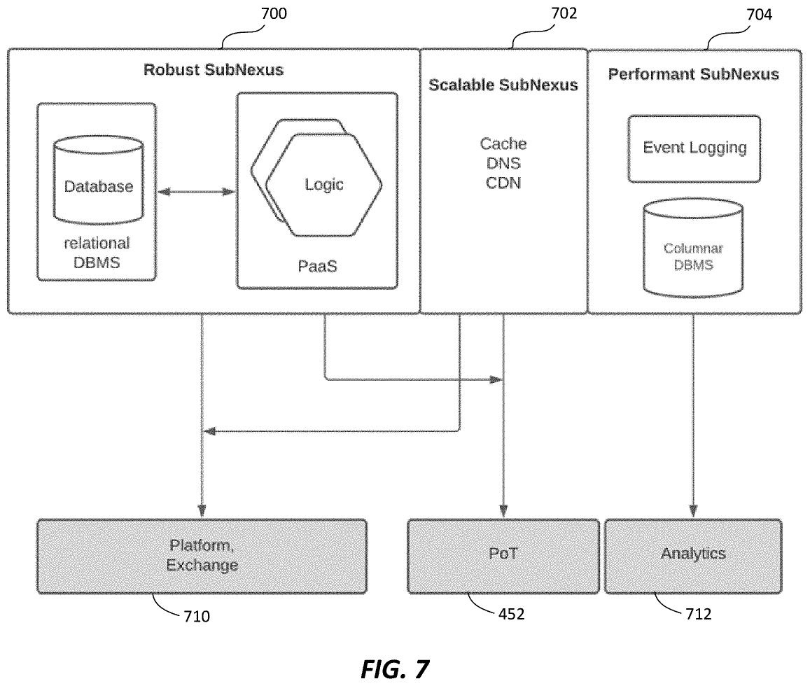

FIG. 7 is a block diagram depicting an exemplary architecture for the nexus 402 and adjacent services, according to one embodiment. Three exemplary core components 700, 702, and 704 are shown. Highly secure and robust mission-critical systems with necessary redundancy may be implemented within a first area 700. The highly scalable and available systems may be implemented within a second area 702, typically using third-party infrastructure. The systems of the first area 700 and the second area 702 may be used for platform exchange 710 and/or the PoT 452. The highly performant components may be used for analytics 712 and other data processing and analysis purposes, and may be implemented in a third area 704.

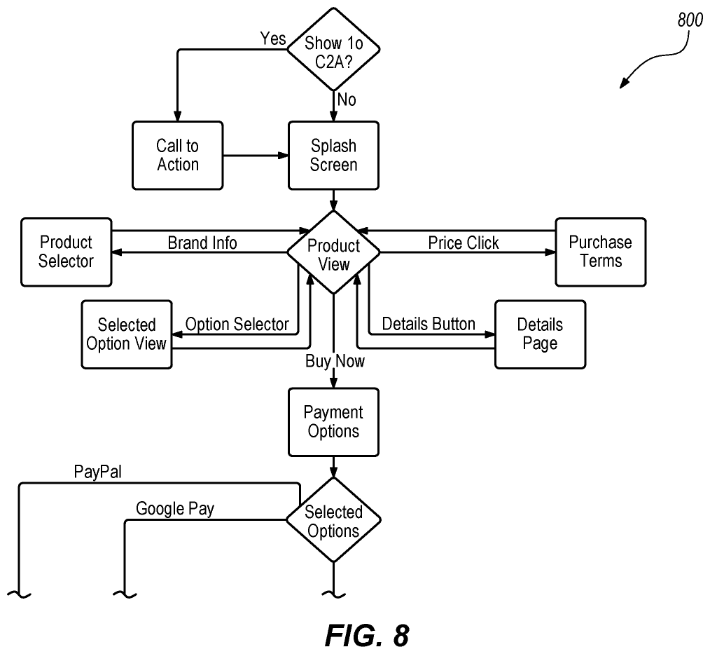

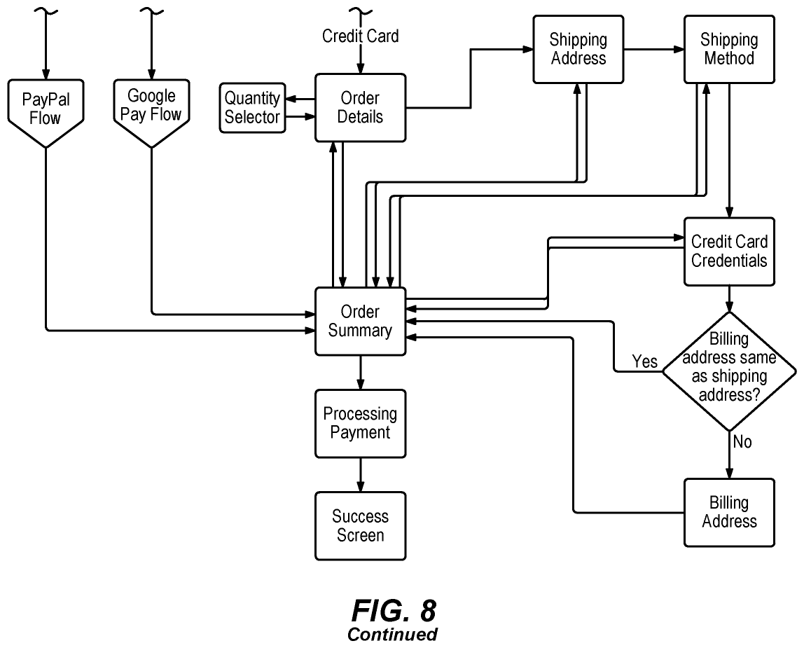

FIG. 8 is a flow diagram depicting a finite state machine 800 with different stages in the e-commerce purchase transaction process. Each of these stages can trigger analytics events irrespective of the technical properties of the consumer's platform. Different types of transactions may be associated with their own respective finite state machines. The flow of FIG. 8 is merely exemplary.

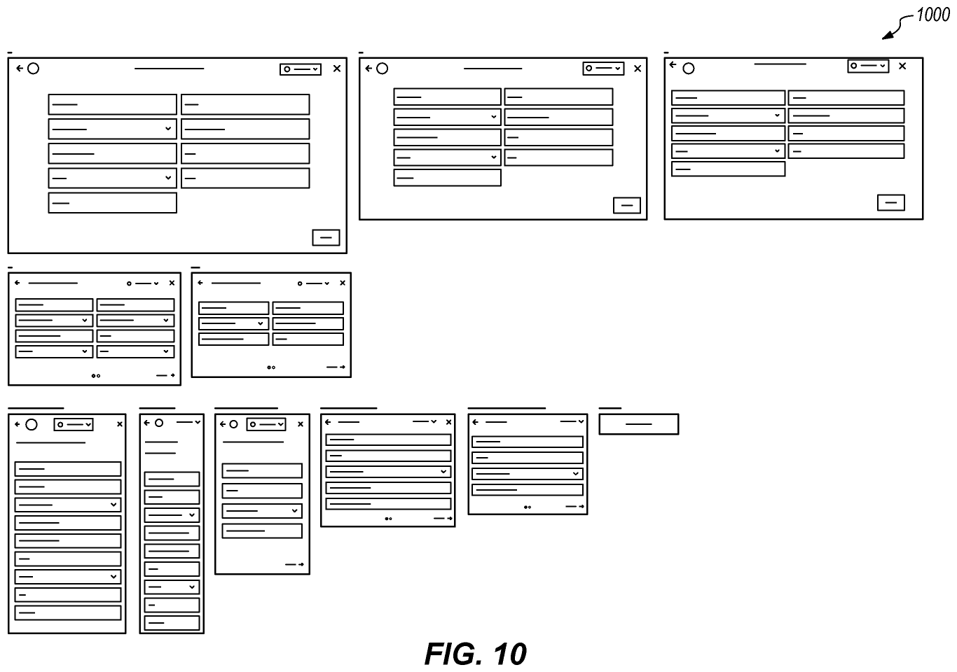

FIG. 9 and FIG. 10 are screenshots depicting a variety of responsive designs 900 and a variety of designs 1000, respectively, generated to allow for the PoT 452 to function with a variety of constraints on the publisher platform 420. These responsive designs 900, 1000 may allow the PoTs 452 to easily integrate with articles, videos, images, advertisements, virtual reality environments, and the like. The particular layout, size, shape, color selection, transaction flow, and/or other characteristics of the PoT 452 may be selected based on factors such as the type of content associated with the product, the type of publisher platform 420 involved, the type of product being offered, and/or the like. Responsive designs 900 may be the result of application of adaptive design according to one embodiment, wherein a k-shop unit 2304 may be displayed in various sizes, layouts, and formats depending on current window size and shape.

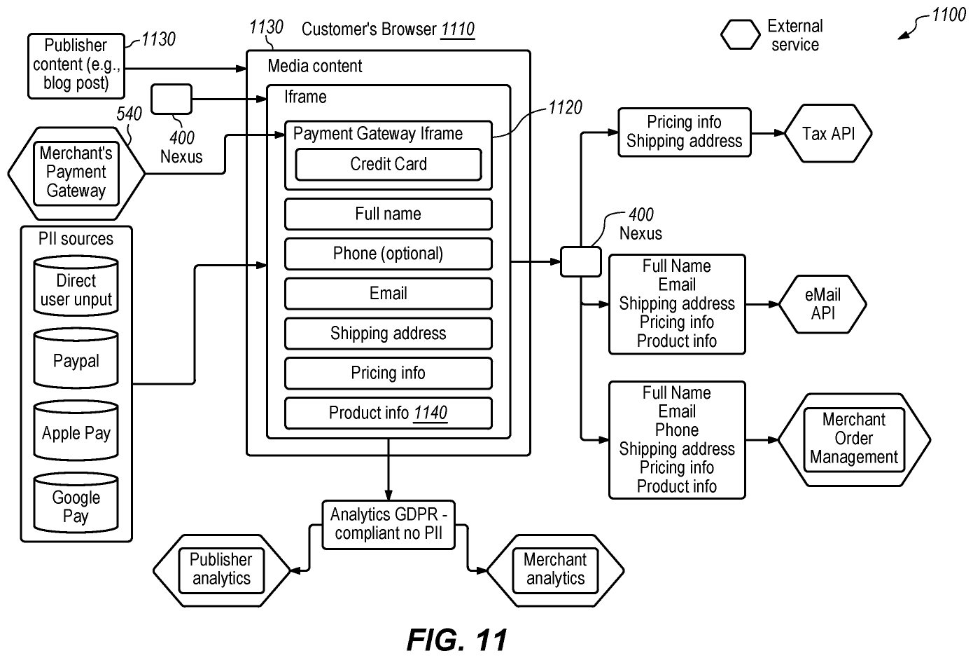

FIG. 11 is a block diagram depicting an exemplary security model 1100 associated with the insertion of the PoT 452 into the content transmitted from the publisher platform 420 to the customer's browser 1110, according to one embodiment. The frame 1120 depicts an implementation of the conduit between the payment processors 540 utilized by the merchant and the customer's browser 1110, isolating it from both the described system 400 (“nexus”) as well as the publisher's system, which provides the content 1130 with which the product is associated. FIG. 11 also depicts some of the data structures present in or mirrored through the nexus 400, including for example, product information 1140, including name, pricing rules, taxation rules, gallery, variants, and/or the like.

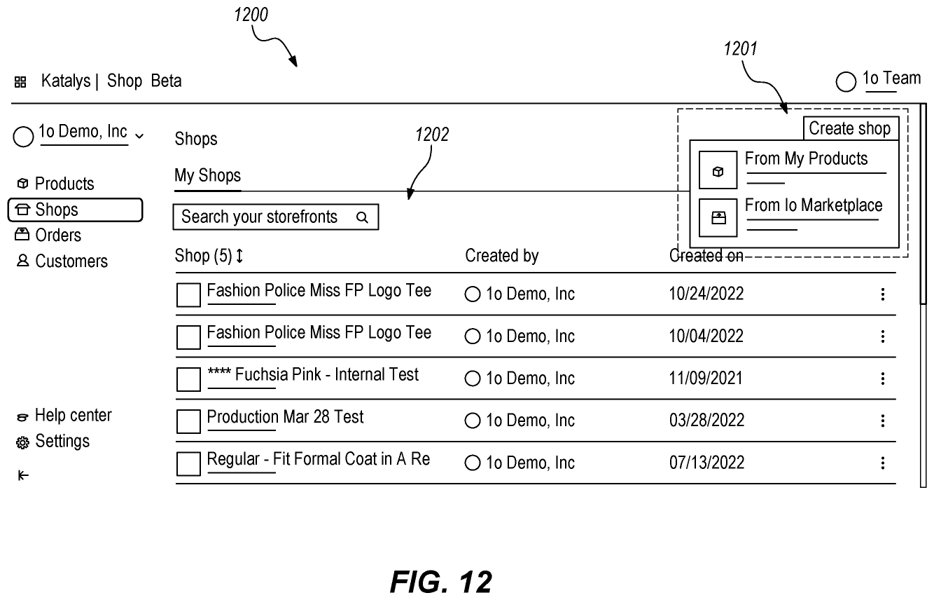

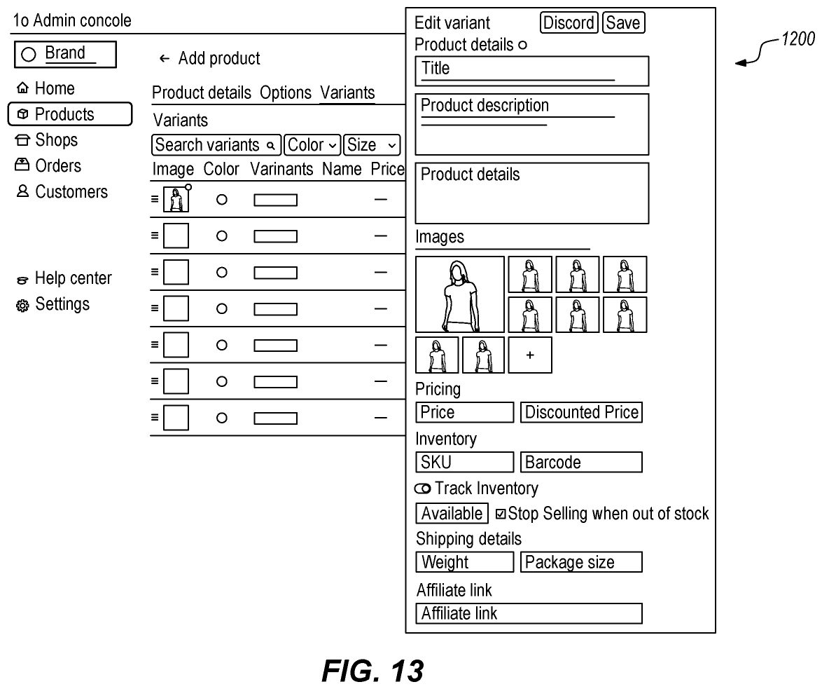

FIGS. 12 and 13 depict the platform interface 1200 used for management of product offerings, according to one embodiment. A subset of the platform functionality may be used by marketing agents that act on behalf of merchants but with a more limited authority, and/or media who can annotate the offers with additional context and information. A list 1202 of shops is provided, along with a user interface 1201 for creating a shop.

In various embodiments, the described system provides the following functionality and advantages:
1. A software bridging mechanism that allows merchants to transact (whether making purchases, indicating interest in products or services, or conducting other sorts of transactions) on partner sites without the system becoming an in-between merchant of record, comprising any or all of the following, in any suitable combination:
   a. A responsive interface that can operate the foregoing functionality in a variety of dimensions, layouts and formats, increasing the versatility and minimizing the integration cost for media;
   b. Optional functionality allowing parties to avoid creating preferential treatment or replicating the functionality that may be typically carried out by merchant, media, or consumer platforms by establishing a common ground for interoperability between such platforms;
   c. Optional functionality allowing a media property to concurrently present offerings from multiple merchants on the same property or in the same context, thus avoiding favoritism towards any merchant;
   d. The provision of a superior level of security by preventing any stakeholder's platform from excessive information access belonging to other stakeholder platforms. For example, not permitting a merchant to access the credit card information belonging to the visitor except through a tokenization system—or not permitting a merchant from being able to retarget a visitor who encountered a product on a particular media sites—or not permitting a media company from accessing the visitor's personally identifying information;
   e. The provision of a superior level of transparency by ensuring any stakeholder's platform to information regarding transactions. For example, ensuring a publisher platform to access the transaction log, or fine-grained analytics about the purchase path;
   f. The utilization of simplified and embedded points of transaction to minimize complexity for the visitor in examining the offer, thereby boosting conversion rates;
   g. The utilization of the bridging mechanism and the simplified points of transaction to minimize the information a visitor needs to share to complete a transaction;
   h. Optional presentation and execution of points of transaction within Iframes, thereby protecting the environment in which such points of transaction may be embedded;
   i. Optional assurance of transparency with regard to any intermediaries or media involved in a transaction, making the visitor aware of any stakeholders in a transaction and their incentives;
   j. Optional deployment of business rules based on information related to a visitor, such as their transaction history;
   k. The inclusion of an option for a visitor to opt out of the bridging mechanism and conduct a transaction directly with a merchant or other intermediary if the visitor so chooses; and/or
   l. The inclusion or integration of attribution mechanisms and metrics when a visitor opts out of the bridging mechanism and completes a transaction elsewhere, to credit the partner site on which the visitor interacted with the bridging mechanism for an eventual sale elsewhere.
2. Conduits for information to be transmitted directly between parties that allow an intermediary such as the foregoing bridging mechanism to avoid receiving certain sensitive information, by leveraging technologies such as cryptography and cryptographic computing.
3. The facilitation and automatic enforcement of a variety of agreements between merchants, media and their service providers regarding which parties should receive what data, including in some cases the aggregation of data to protect the privacy of the data.
4. The further use of cryptographic computing to enforce agreements between third parties such as those set forth in item 3 without revealing certain sensitive information to an intermediary enforcement mechanism, such as one that may be part of the functionality of the mechanism described in item 1, without such enforcement mechanism ever having direct access to such underlying sensitive information.
5. The facilitation and enforcement, via the conduits set forth in item 2 and with potential reference to the agreements set forth in item 2, of variety of agreements between stakeholders set forth in item 1 with regard to how transaction proceeds will be apportioned, comprising any or all of the following, in any suitable combination:
   a. Agreements with regard to the apportionment of transaction proceeds set forth in software;
   b. A software mechanism for enforcing those agreements;
   c. An optional software mechanism for the movement of actual funds in reference to such agreements;
   d. Optional integration with escrow services;
   e. Optional integration with government and other regulatory agency reporting and compliance; and/or
   f. Optional integration with other ancillary financial services;
6. Domain specific programming languages that may be used to specify the agreements between stakeholders, the virtual machines for the execution of such agreements, integrated development environments, libraries, documentation systems, and/or debuggers for the development of such agreements.
7. A conduit whereby the facilitator never touches personally identifying information, and may merely establish the connection between customer's device and merchant's systems. In some cases, the conduit may use a tokenization system to ensure the customer's information is protected. The merchant may also using a tokenization system themselves. In other cases, a cryptographic signature may be made for service agreement compliance purposes.
8. A fetch—send—delete paradigm.
9. In at least one embodiment, the system can go beyond merely projecting merchant-supplied information, as with advertising, but can also add third party information about the product.
10. In at least one embodiment, the icon may be a relatively small element within the interaction surface that the user may associates with the product and may engage with. The user may express interest in the product by touching, hovering, clicking on any (subset) of that.

### Example

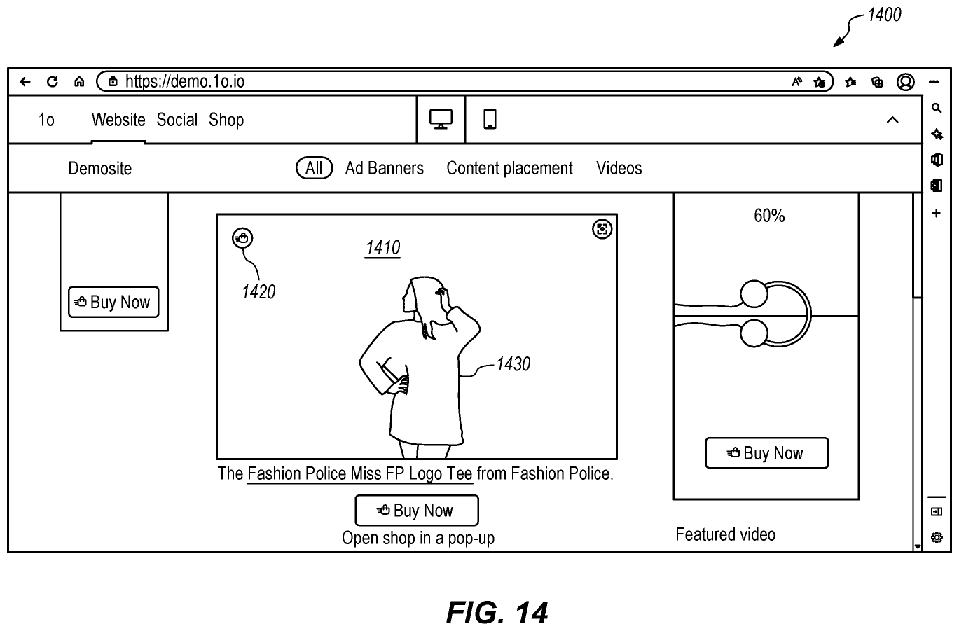

The systems and methods of the present disclosure may be implemented in a wide variety of ways. One example will be set forth in connection with FIGS. 14 through 18 and 30 through 42.

FIG. 14 is a screenshot 1400 depicting content 1410 in the form of a picture that is being displayed for a user, according to one embodiment. In other embodiments, the content may be a video, sound, virtual reality or augmented reality experience, and/or the like. An icon 1420 may be shown in connection with the content 1410. The user may select the icon 1420 (for example, by clicking or tapping on it) to indicate interest in purchasing a product 1430 associated with the content 1410 (for example, the shirt worn by the person depicted in the content 1410).

In the example of FIG. 14, the icon 1420 may be superimposed on the content 1410, providing the user with a clear indication that it is associated with the content. In alternative embodiments, the icon 1420 may be positioned differently, for example, outside the frame in which the content 1410 is delivered. In some embodiments, the icon 1420 may not be displayed until the user takes some action, such as activating the frame, hovering over the content 1410 with a pointer, and/or the like.

In FIG. 14, the user may hover over the icon 1420 to expand it, showing how the user may be able to interact with the content 1410. Such interactions may include sharing, commenting, social media linking, newsletter subscriptions, saving to a “wish list” or other user-specific interest board, purchasing associated product, and/or the like. As implemented in FIG. 14, hovering over the icon 1420 may expand the icon 1420 to show that it can be used to purchase the product 1430.

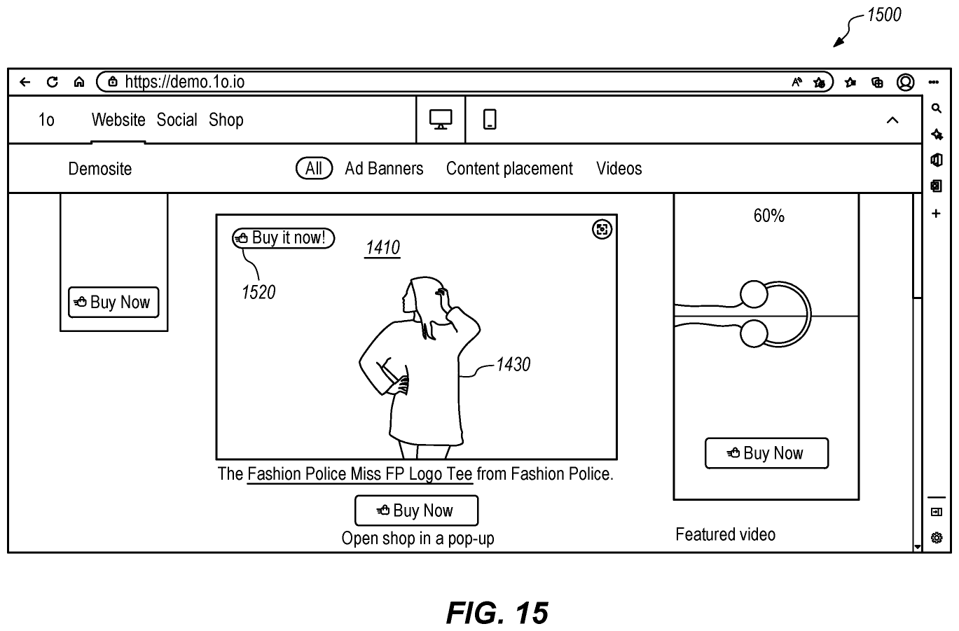

FIG. 15 is a screenshot 1500 depicting the content 1410, with an expanded icon 1520 shown in response to user selection, such as hovering over the icon 1420 of FIG. 14. As shown, the expanded icon 1520 shows that the user can use it to purchase the product 1430 associated with the content 1410. Selecting the expanded icon 1520 may lead to display of a transaction window by which the user can purchase the product 1430.

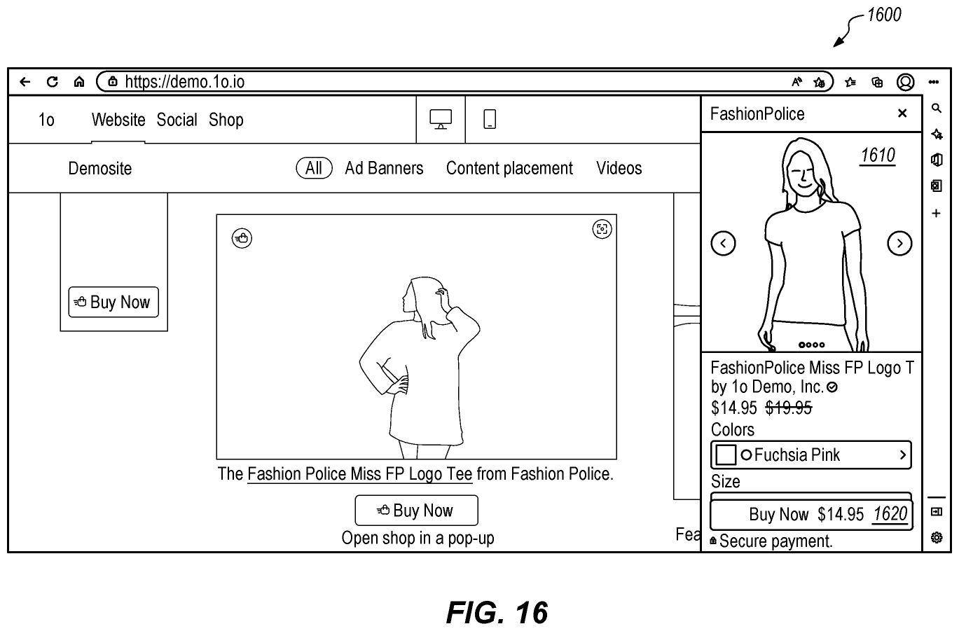

FIG. 16 is a screenshot 1600 depicting a transaction window 1610, which may be displayed in response to user selection of the expanded icon 1520 in FIG. 15. The transaction window 1610 may be displayed without navigating away from the content 1410. This may be advantageous for the publisher of the content 1410, as it may facilitate continued interaction with the content 1410 by the user, or continued interaction with other content on the page or elsewhere on the publisher's website.

As shown in FIG. 16, the transaction window 1610 may be displayed to the side of the content 1410 so that the user can continue to reference the content 1410 during the purchase process. The content 1410 may optionally be darkened as shown to make it clear that the user is now interacting with the transaction window 1610. In alternative embodiments, the transaction window 1610 may be superimposed over some or all of the content 1410; this may be done in a way that the user knows they have not navigated away from the publisher's site, and can easily return to the content 1410.

The transaction window 1610 may show information to facilitate the user's purchase of the product 1430, such as available colors, styles, sizes, pricing, etc. The user may select a purchase button 1620 to proceed further with the purchase.

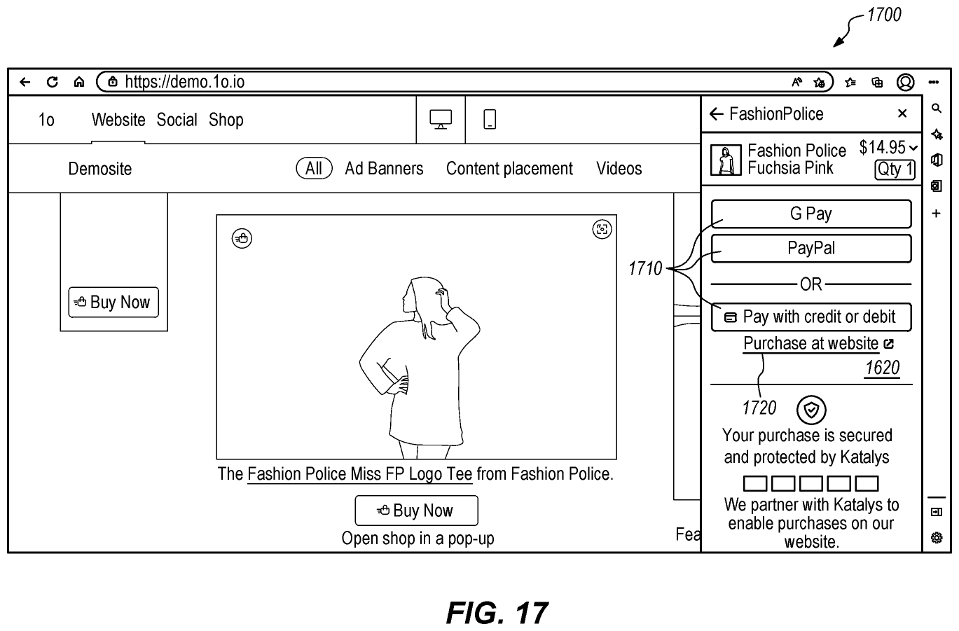

FIG. 17 is a screenshot 1700 depicting the next stage in the transaction, after the user has selected the purchase button 1620 of FIG. 16. The user may also have made other selections, such as the color, size, and/or particular style of the product 1430 they wish to purchase.

As shown, the transaction window 1610 may now show payment options 1710 that can be selected by the user to choose how to pay for the purchase. Optionally, the transaction window 1610 may also display a link 1720 that enables the user to navigate to the merchant's website to complete the purchase there. Advantageously, however, the transaction window 1610 may provide all functionality needed to purchase the product 1430 without the need to navigate to the merchant's website.

The transaction window may be hosted and/or displayed by a third party apart from the publisher and the merchant. The third party, i.e., the “facilitator,” may serve as an intermediary between the publisher and the merchant. In some embodiments, the transaction window 1610 may serve as a conduit for information from the user to convey the information directly to the merchant, without being stored and/or retained by the facilitator. Such an arrangement may make it easier for the merchant to enter into the relationship, knowing that they will retain control of the data associated with the purchase.

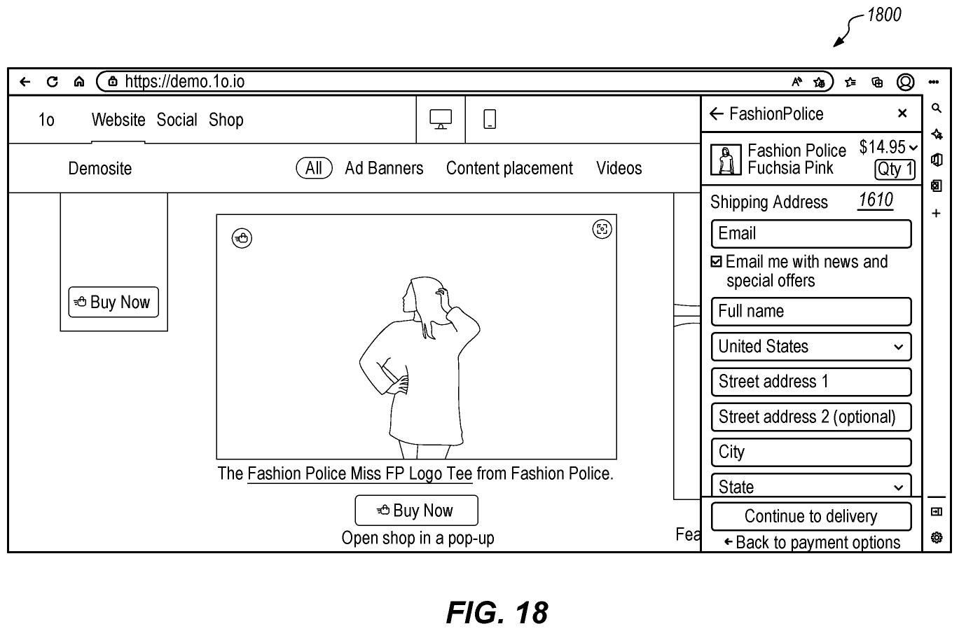

FIG. 18 is a screenshot 1800 depicting the transaction window 1610 after payment has been selected and/or entered. As shown, the user can now enter shipping information and/or the like. After entering all required payment and fulfillment information, the user may select a “complete purchase” button or the like (not shown) to finalize the purchase and transmit the purchase order to the merchant. Such a purchase order may be sent via the merchant's website or via other channels.

The transaction flow illustrated herein may beneficially ease the experience of a consumer roaming and browsing the digital realm as it catches the moment when the consumer's attention may be peaking high. The facilitator may capture that very moment and allow a consumer to make an instant purchase of a product when they show their interest in a specific product. The system thereby reduces or eliminates friction in e-commerce interactions by avoiding the need for the consumer to be redirected to a new tab or a new page, where they would otherwise be required to familiarize themselves with a different website and potentially lose interest in purchasing the item.

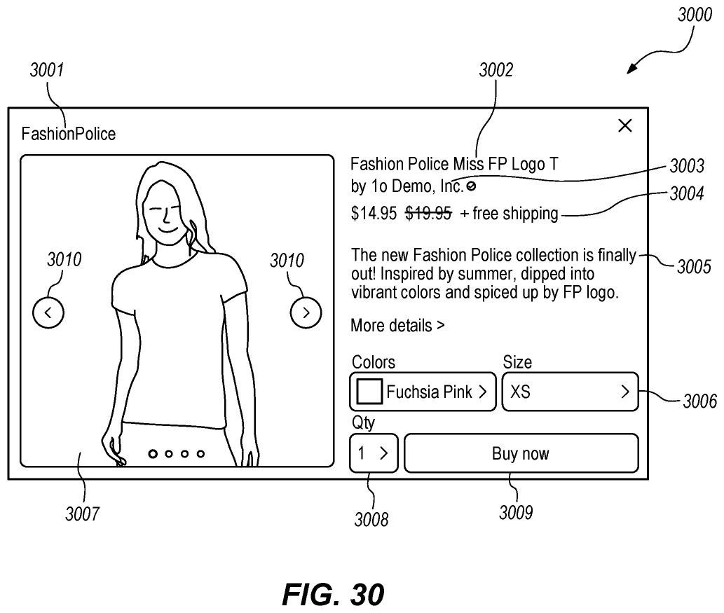

FIG. 30 is a screenshot depicting a k-shop home screen 3000 according to an alternative layout. The following elements may be included in k-shop home screen as depicted in screenshot 3000:
Brand logo 3001;
Title of item 3002;
Brand 3003;
Price 3004;
Description 3005;
Options selector 3006, for selecting options such as color and/or size;
Gallery 3007, for presenting images and/or photos depicting the product, controllable and/or selectable via arrow buttons 3010;
Quantity selector 3008; and
Buy now button 3009.

The user may select options via options selector 3006 and quantity via quantity selector 3008, and may click on buy button 3009 to initiate a product purchase, all without navigating away from the product page.

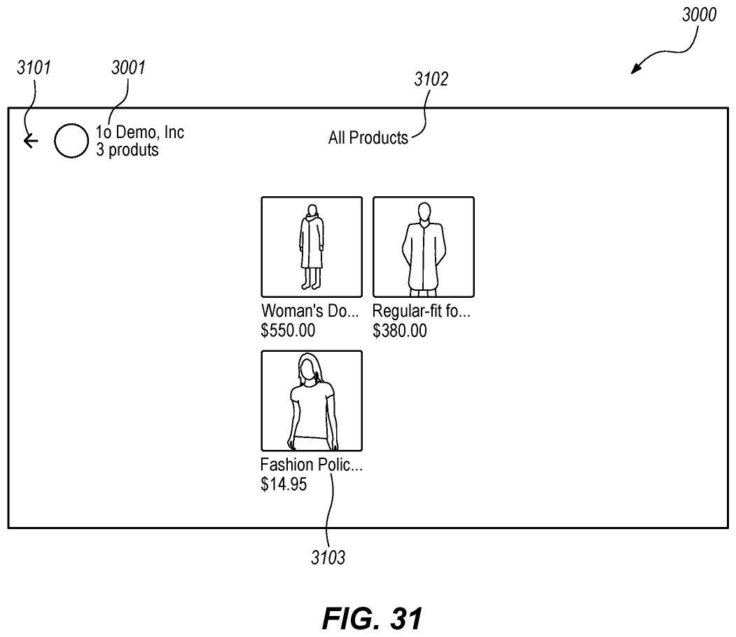

FIG. 31 is a screen shot depicting a brand/all products view 3100 according to one embodiment. View 3100 may present other products 3103 featured in the same shop as shown in FIG. 30. View title 3102 reminds the user that all products within the shop are being shown. The user may click on arrow 3101 to return to home screen 3000.

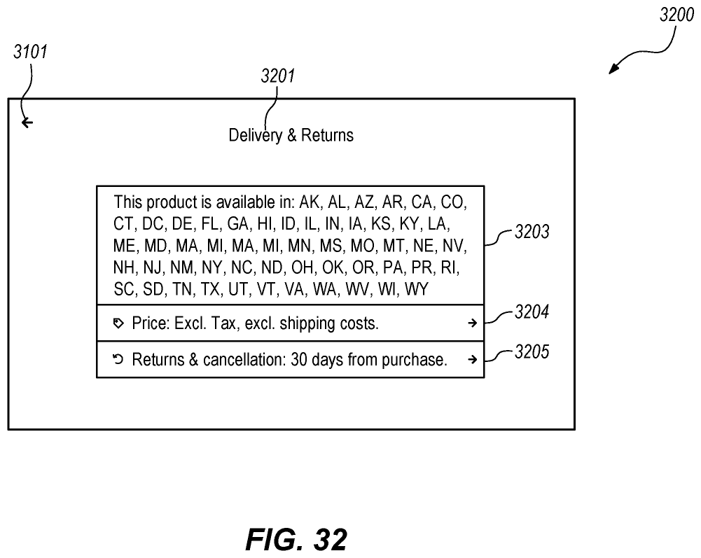

FIG. 32 is a screen shot depicting a k-shop information view 3200 according to one embodiment. View title 3201 indicates that the current screen is showing delivery and returns information. In this example, the information shown includes available countries 3203 (indicating those countries from which orders can be placed), price details 3204, and returns and cancellation details 3205. Again, the user may click on arrow 3101 to return to home screen 3000.

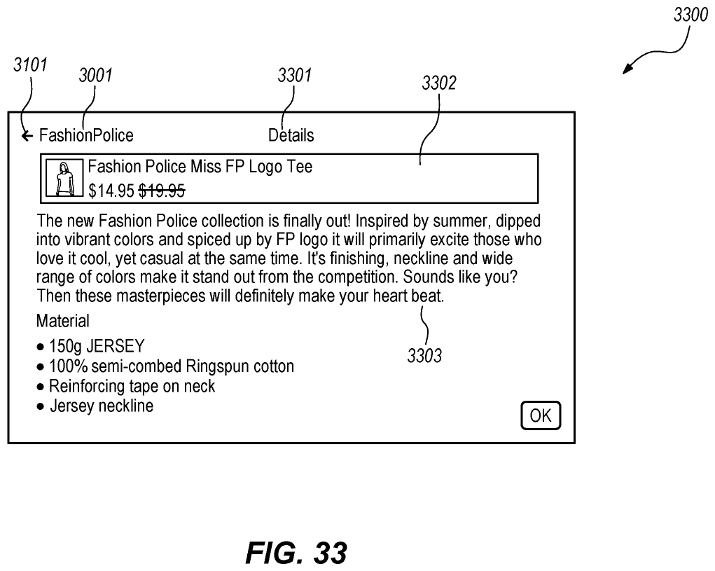

FIG. 33 is a screen shot depicting a more detailed view 3300 according to one embodiment. View title 3301 indicates that the current screen is showing details about a product. In this example, the information shown includes details/description 3303. Again, the user may click on arrow 3101 to return to home screen 3000.

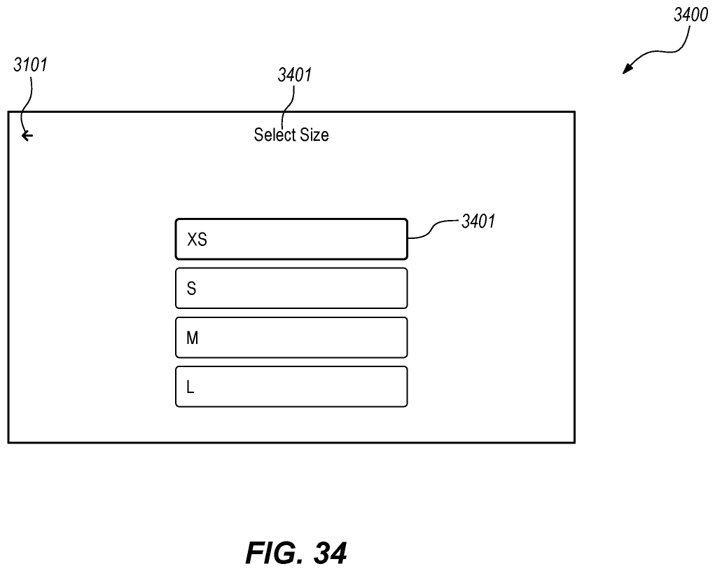

FIG. 34 is a screen shot depicting an options view 3400 according to one embodiment. View title 3401 indicates that the current screen is showing available sizes for a product. The user can select from available sizes/options 3401. Again, the user may click on arrow 3101 to return to home screen 3000.

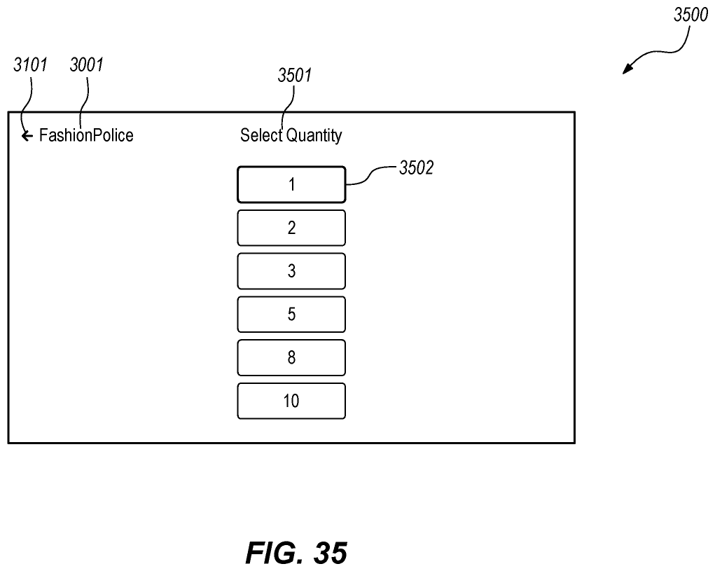

FIG. 35 is a screen shot depicting a quantity selector 3500 according to one embodiment. View title 3501 indicates that the current screen is a quantity selector. The user can select a quantity 3502. Again, the user may click on arrow 3101 to return to home screen 3000.

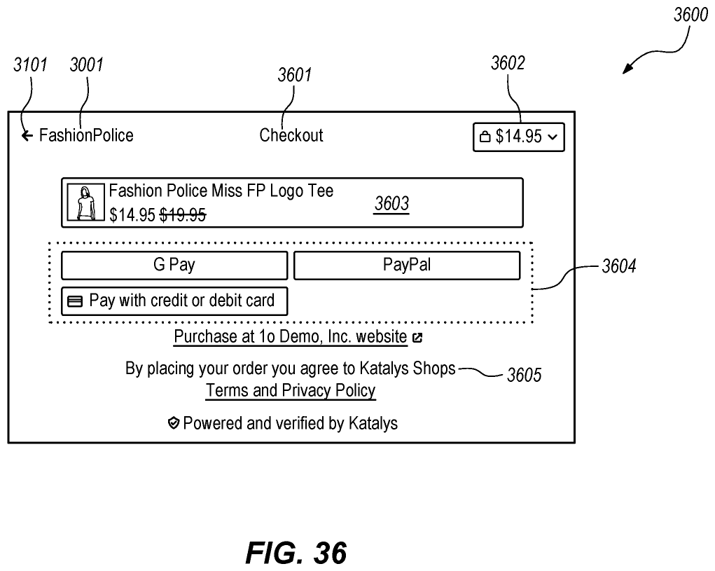

FIG. 36 is a screen shot depicting a checkout view 3600 according to one embodiment. View title 3601 indicates that the current screen is a checkout screen. An order breakdown 3602 is shown, along with description 3603 of the items in the user's cart and terms of service 3605. The user may select among available payment options 3604. Clicking one of the payment buttons causes checkout to take place at the merchant's website via a redirect. Again, the user may click on arrow 3101 to return to home screen 3000.

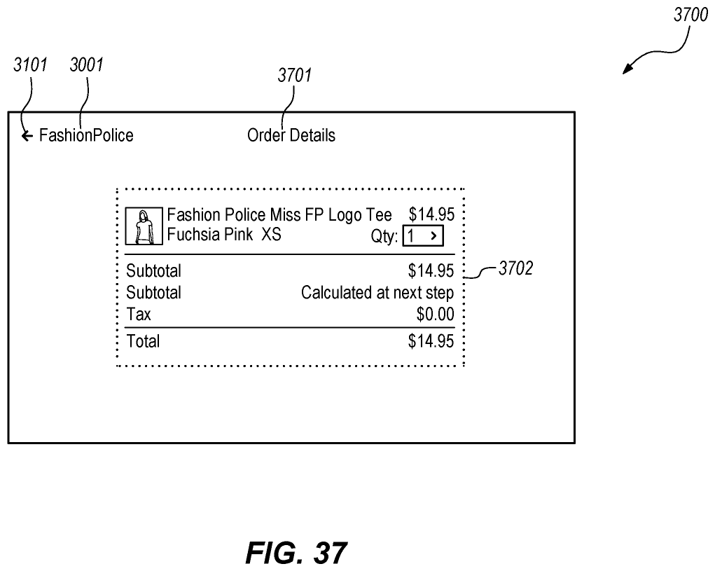

FIG. 37 is a screen shot depicting an order details view 3700 according to one embodiment. View title 3701 indicates that the current screen is an order details screen. Order details 3702 are shown. Again, the user may click on arrow 3101 to return to home screen 3000.

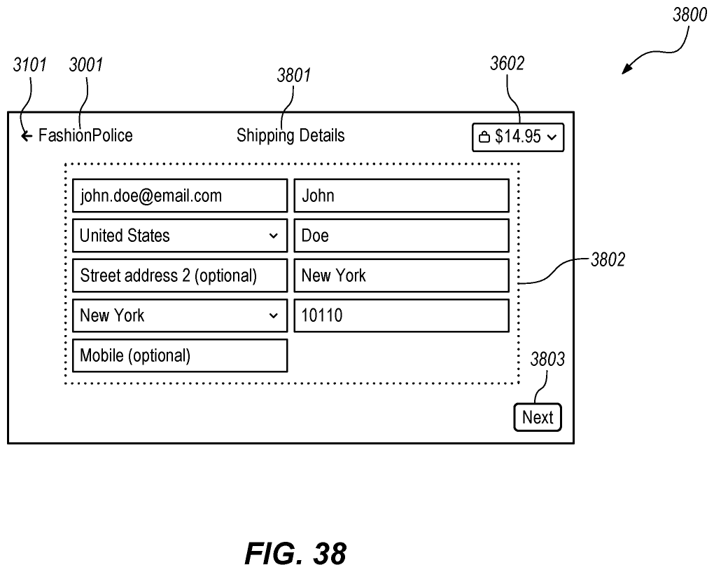

FIG. 38 is a screen shot depicting a shipping address view 3800 according to one embodiment. View title 3801 indicates that the current screen is a shipping address screen. The user may provide shipping details in shipping details entry area 3802, and may click Next button 3803 to proceed. Again, the user may click on arrow 3101 to return to home screen 3000.

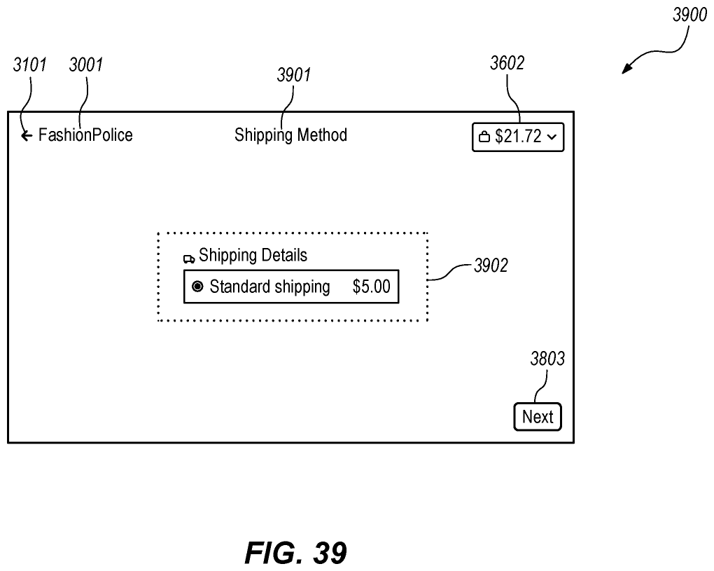

FIG. 39 is a screen shot depicting a shipping method view 3900 according to one embodiment. View title 3901 indicates that the current screen is a shipping method screen. The user may select a shipping method via shipping method selector 3902, and may click Next button 3803 to proceed. Again, the user may click on arrow 3101 to return to home screen 3000.

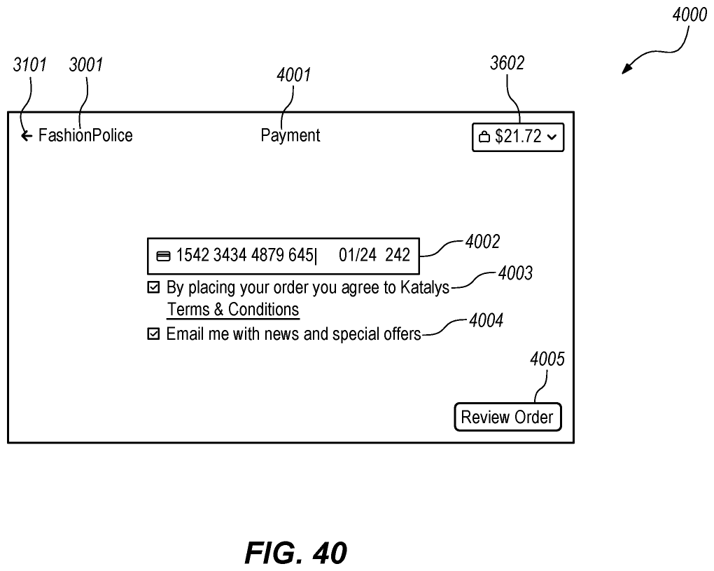

FIG. 40 is a screen shot depicting a payment view 4000 according to one embodiment. View title 4001 indicates that the current screen is a payment screen. The user may enter credit card details in field 4002, may accept terms and conditions 4003 and email marketing preferences 4004, and may click Review Order button 4005 to proceed. Again, the user may click on arrow 3101 to return to home screen 3000. In at least one embodiment, marketing preferences 4004 may be hidden to simplify the purchase journey.

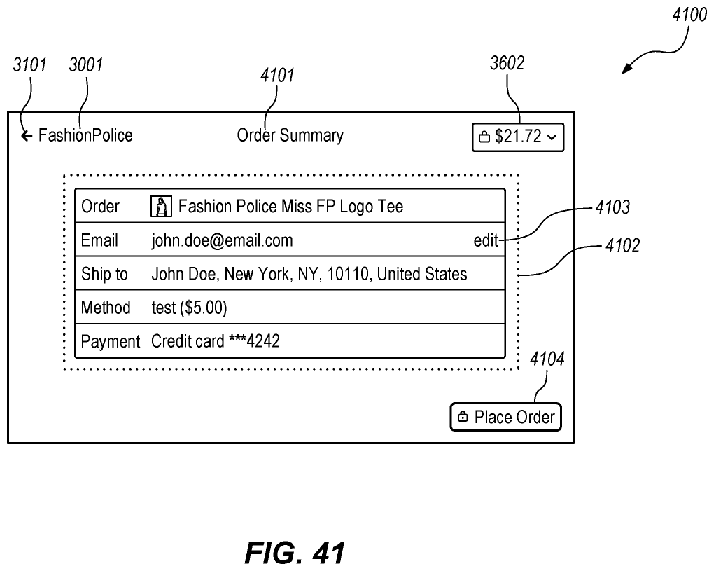

FIG. 41 is a screen shot depicting an order summary view 4100 according to one embodiment. View title 4101 indicates that the current screen is an order summary screen, including an order summary 4102. The user may edit the order by clicking on Edit button 4103, or may click Place Order button 4104 to proceed with the order. Again, the user may click on arrow 3101 to return to home screen 3000.

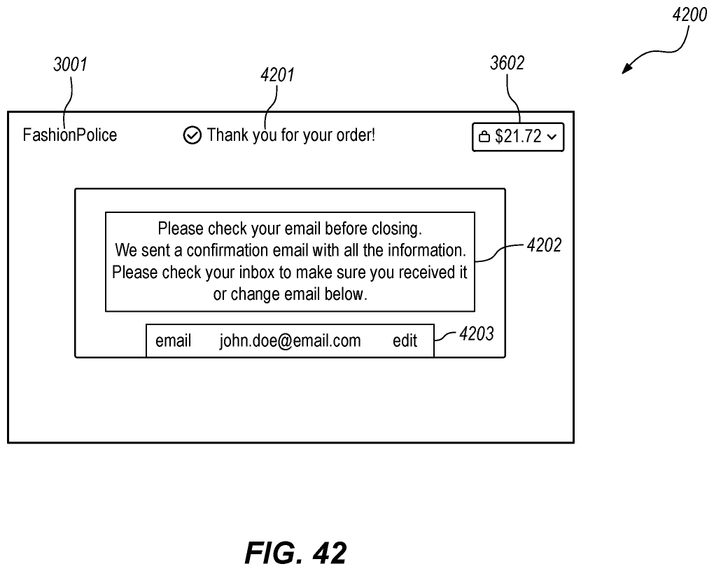

FIG. 42 is a screen shot depicting a thank you page 4200 according to one embodiment. View title 4201 indicates that the current screen is a thank you page, including order info 4202. The user may edit email settings in field 4203. In at least one embodiment, the user may be required to confirm the receipt of the email through a link in the email as to minimize the risk of an erroneous address entry. A telephone number or an instant messaging channel may be used instead of or in addition to the email address.

### Contract Between Merchant and Publisher

As mentioned previously, the facilitator may serve as an intermediary between the publisher and the merchant. This may include the provision of a contract that can be executed by the publisher and the merchant that establishes the terms of their collaboration to sell the product 1430.

The facilitator may offer the system and method set forth in the present disclosure as a manifold solution. While the transaction flow of FIGS. 14 through 18 may take place on the surface and may be made visible to parties interacting with each other online, the facilitator may also cover the back-end solutions that help build a strong and reliant relationship between a consumer, seller and their intermediary, who may be an affiliate such as a publisher. With an instant purchase button solution, sellers and affiliates may become changemakers and tap into the world where they can gain more insights about consumers' interests with fewer intermediaries. While this may provide some security and privacy benefits, it may also bring a much-needed Web2 optimization to progressively lead towards the adoption of Web3 information technology.

By reducing friction in e-commerce transactions and enabling more efficient sales to take place, the described system allows merchandisers and affiliates to use technological advancements to provide faster, quicker, and more efficient visibility on the market. Relationships can thus be driven by powerful algorithms and data points adjusted by the technology associated with digital advertising. The facilitator may help to plan, strategize, and manage digital advertising activities. While many aspects of e-commerce have been automated over the last decade, the systems of the present disclosure can make collaboration between publishers and merchants much more participatory, open, and easy to implement. The high costs of existing added value centralized intermediaries can be replaced with a system that allows merchandisers and affiliates to define their own sets of rules and manage these relationships without the need for a brokerage service.

More particularly, the facilitator may offer automated transaction flows and/or pay-outs when deliveries and key performance indicators (KPIs) are met. In some embodiments, content that can be delivered through the platform may have an associated content rating indicative of the types of products that can be offered in connection with it. The content rating may be related to the quality of the content, the market it will appeal to, the ages for which the content may be suitable, the popularity of the content, and/or other factors. As part of the onboarding process, the merchant may establish the content ratings that may be suitable for each product to be offered under the platform. Artificial intelligence may be used to optimize the pairing of products with content, using data from consumer responses to products historically offered in connection with content.

The facilitator may deliver a collaboration that may be consistent with the growing trend that suggests individuals or organizations should be the ones controlling and managing their own data. Automated data processing may be used to accomplish these objectives. It may be helpful to start with a topology of data crossing through platforms while tapping into the business of online purchases.

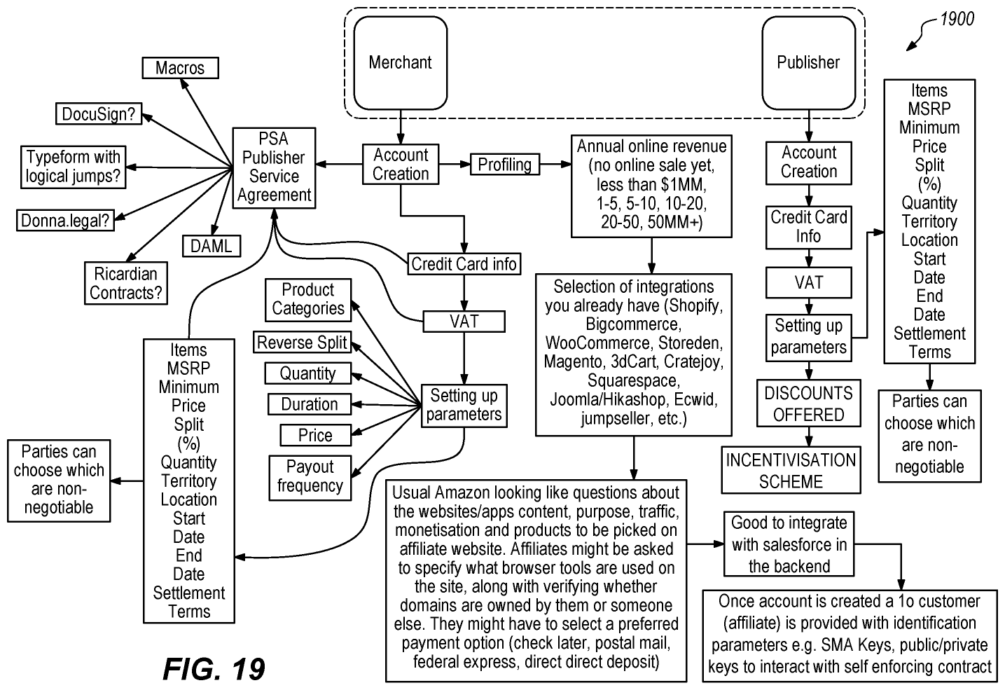

FIG. 19 is a block diagram 1900 depicting data that may be collected in connection with an online purchase. The facilitator may advantageously minimize data flows and retention to maintain privacy and help the publisher and the merchant to retain control of the data that may be most pertinent to their operations. The facilitator may further facilitate these data control policies through the contract (“service agreement”) executed by the publisher and the merchant.

In order to establish the relationship between the publisher and the merchant, the facilitator may collect profiling information through an onboarding platform in which merchants may be asked about their current service providers, size, countries they operate in, areas of interests, revenue streams, funnels and marketing tactics already in use, website/app content, purpose, traffic, monetization, and/or products to be placed on the affiliate website. Affiliates may be asked to specify what browser tools may be used on the site, along with verifying whether domains may be owned by them or someone else. They may select a preferred payment option. This profile may optionally be established based on responses to a questionnaire or survey. Information may be used to populate a merchant's profile and service agreement, which can be reviewed once the profiling process is completed and approved. The service agreement and/or a term sheet representative of the service agreement can be further electronically presented to and/or signed by the merchant.

The merchant's payment information may include one or more bank account numbers that can receive revenue streams, selection of applicable tax rate(s), and a selection of payment method (credit cards, PayPal, Venmo, gift cards, online credits, and/or others) through which the merchant may be charged for operational costs or other expenses applicable on the platform.

Matching search parameters may include product categories, revenue splits, quantities, duration of an advertisement space availability, price of such space, pay-out frequency, influencer's reach and engagement statistics, platforms where publishers may be present, and/or the like. Any or all of these parameters may be displayed in the form of basic parameters and/or advanced parameters. In at least one embodiment, the display may be dependent on the category of products and services offered or searched for and other merchant's profiling information collected through the onboarding process.

Service agreement parameters may include information that may otherwise be made part of the contract or order form. These may define the items merchants may be putting on the market, MSRP, minimum price, revenue split, a quantity of the items displayed, territory/location where advertisement shall be displayed, other topography information of target market, start/end date of the advertisements, and/or settlement terms. The most important parameters may be predefined and/or provided to merchants as recommendations based on observations of best practices. Merchants may also be provided with the option of choosing which of these parameters are set as they are, choosing possible deviations, and/or marking that the parameters are fully negotiable and can change based on the counterparty requirements. This can be further compared to different types of orders one can see on various stock exchanges—limit order, market order, and/or the like.

Suitable variables for the service agreement may include, but are not limited to, any of those collected by existing eCommerce platforms. For example, parameters from any of these platforms may be used:
Google Shop standardization (haps://support.google.com/merchants/answer/7052112?hl=en);
Shopify MarketPlace Kit (https://shopify.dev/marketplaces); and/or
The Skimlinks API (https://developers.skimlinks.com/).

Functionally, setting up the service agreement may be similar to the use of automated market makers, which may be algorithmic agents responsible for maintaining open interest in electronic markets. Automated makers have been applied successfully to create new prediction markets that would not exist without the intervention of liquidity-providing agents. In some embodiments, the system provided by the facilitator may utilize any existing tools built around smart contracts and residing on L2 of Web3 in order to form a prediction market and ease the experience of entering into, withdrawing from, and/or terminating a service agreement between a publisher and a merchant.

The service agreement may be provided on a secondary layer built on top of a basis that has already been programmed in such a way that may be compatible with further data indexing, matching and processing. To make optimal use of time spent on the platform, the onboarding process may be composed of questions and logical jumps that help identify merchant demands on the market. The gathered information may be used to draft the contractual relationship between the merchant and the facilitator. Contractual relationships between the publisher and the facilitator, and between the merchant and the facilitator, may be established separately and then combined to form a contractual relationship between the publisher and the merchant.

The onboarding process between the facilitator and the merchant may be set in such a way that all collected information provided by the parties while onboarding already constitutes the basic elements of the agreements defining the terms between the facilitator and the merchant. These same data may be integrated within the platform (i.e., the system) to create a unique profile page for the new merchant.

To reach a higher level of privacy, the system may use tools that may be tapping into the Web3 domain and aligning the facilitator's values and interest with the growing demand of merchants to control and take ownership over their own data. The creation of personal profiles may thus be linked to sovereign identity

The main parties interacting on the system may be merchants and publishers. One offers products and services, the other one advertisement space and promotion. The system may provide a marketplace in which they meet and offer an opportunity to buy ad placements on the publishers' websites through various different sales techniques and with predefined parameters to negotiate the best possible outcomes.

Decentralization may provide a new power play, allowing for more participatory manifestation, distribution and utilization of the information provided among the various different merchants and stakeholders. Once market participants can capture and offer the needed data themselves, and rely on algorithms and/or data analytics that do not sell such data further, the resulting chain of trust may help parties improve conditions on the market and establish better business practices.

The system may enable merchants to generate their own profiles utilizing technology such as IDex and Ceramic networks. This technology may allow them to store and use data if and when the owner of the data so decides and only reveal it to those selected by the merchant.

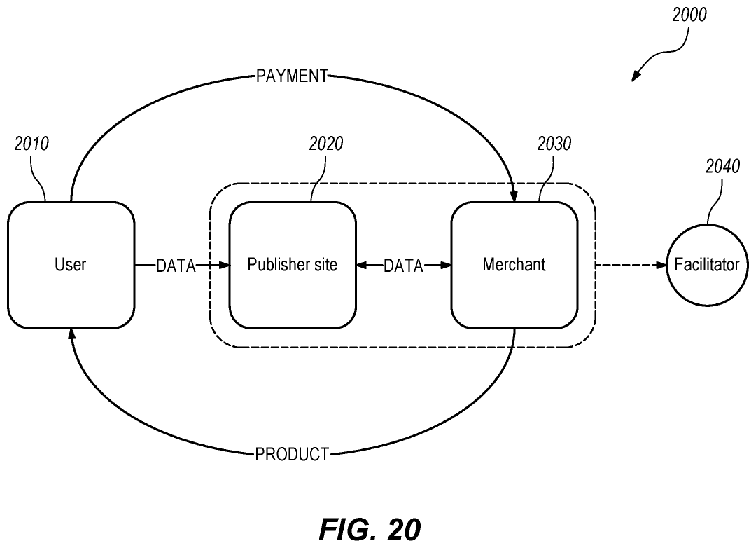

FIG. 20 is a schematic block diagram 2000 depicting flows of data between the user 2010, the publisher 2020, the merchant 2030, and the facilitator 2040, according to one embodiment.

### Ad Exchange, Supply Side Platform, and Ad Server

In at least one embodiment, the system may include an ad exchange that acts as a dynamic platform to buy and sell ad impressions between advertisers and publishers without any intermediaries. The ad exchange may incorporate any features and/or functionality of any known programmatic advertising platform, including but not limited to Open X, AppNexus, Rubicon Project Exchange, and/or the like.

Further, the system may include a supply side platform (SSP), which may allow publishers to display mobile ad impressions to potential buyers in real-time. The SSP may incorporate any features and/or functionality of any known SSP, including but not limited to MoPub, AerServ, and AppNexus Publisher SSP.

Yet further, the system may include an ad server that can be used by advertisers, publishers, ad networks, and/or ad agencies to run their campaigns. The ad server may determine which ad will be displayed on a website and also collect ad performance data such as clicks and impressions. The ad server may incorporate any features and/or functionality of any known ad server, including but not limited to DoubleClick for publishers, OpenX ad server, and AdButler.

### Exchange Functionalities

The following non-exhaustive list includes exemplary functionalities that may be incorporated into the exchange established by the system.
Sign-in
   A Detailed Questionnaire with logical jumps
   Profile created right away but is not yet verified
Edit Profile
   Company details
   Bank details
   Tax
   Integrations
      Shopify
      Magento
      WooCommerce
      Other possible integrations
   Security
      Username and Password
      2FA
   Notification Settings
   Verification
      Until officially vetted, the profile should not have a “verified” badge and users may have limited access to all Marketplace features
Dashboard for Merchants
   (Existing) Shops
   (Existing) Products
   Add new store/shop
   Add new product
      New product description
   Import Shop
   Import Products
      CSV integration
      Integration of Shopify, Bigcommerce, WooCommerce, Storeden, Magento, Squarespace, Joomla/Hikashop, Ecwid, jumpseller, and/or the like
      NFT integration
   Inquiries
      Pending Offers
      Ongoing
      Closed
      Disputes
Dashboard for Publishers
   Portfolio
      Websites
      Paid Display Ads
      Paid Search Engine Marketing
      Apps
      Browser Extensions
      Emails
      Social Media
      Blogs
      Games
      Metaverse
   Performance
      Statistics
      Reviews
   Inquiries
      Pending Offers
      Ongoing
      Closed
      Disputes
Marketplace Recommendations
Marketplace Search
   Filters
      Merchants/Publishers
      Product Categories
      Promotional models
      Quantity
      Price ratio
      Revenue Split ratio
      Territory/Location
      Target Audience
      Start/End Date
   Sort per
      Price ratio
      Revenue Split ratio
      Duration
      Quantity
   View options
      Big items
      Small items
Marketplace Previous Searches
Search Result Close-up
   User's public information, contact
   User's offer (terms)
   Variables (negotiable terms)
   Submit—entry into a self-executing, potentially renewable contract

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above may be presented in terms of algorithms and symbolic representations of operations on data bits within a memory of a computing device. These algorithmic descriptions and representations may be the means used by those skilled in the data processing arts to convey the substance of their work most effectively to others skilled in the art. An algorithm is here, and generally, conceived to be a self-consistent sequence of steps (instructions) leading to a desired result. The steps may be those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions may be embodied in software, firmware and/or hardware, and when embodied in software, may be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device may include, for example, a processor, an input device (such as a keyboard, mouse, touchpad, microphone, and/or any combination thereof), an output device (such as a screen, speaker, and/or the like), memory, long-term storage (such as magnetic storage, solid state storage, and/or the like), and/or network connectivity, according to techniques that may be well known in the art. Such an electronic device may be portable or non-portable. Examples of electronic devices that may be used for implementing the described system and method include: a smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; MacOS, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for selling products from a merchant via a publisher website hosted by a publisher, the method comprising:
at a hardware processing device, receiving content from the publisher website, wherein the content is associated with a product;
at an output device, displaying, for a user, a web page comprising the content, wherein the web page comprises a portion of the publisher website;
at an input device, receiving first user input from the user indicating interest in the product;
at the hardware processing device, responsive to the first user input, receiving product information about the product from a merchant distinct from the publisher;
at the output device, displaying the product information without navigating away from the publisher's website and without opening a new window and without opening a new tab;
at the input device, receiving second user input indicating a desire to purchase the product without navigating away from the publisher's website and without opening a new window and without opening a new tab; and
responsive to the second user input and without navigating away from the publisher's website, transmitting an order to purchase the product to the merchant.

2. The method of claim 1, wherein displaying the product information comprises displaying at least one of a transaction frame and a transaction window containing the product information, without navigating away from the publisher's website and without opening a new window and without opening a new tab.

3. The method of claim 2, wherein receiving the product information comprises receiving the product information via a facilitator distinct from the publisher and the merchant.

4. The method of claim 3, wherein transmitting the order comprises:
receiving the order to purchase the product at a facilitator website operated by the facilitator; and
initiating a conduit for transmission of at least one of payment information and identity information for the order to purchase the product to the merchant such that the payment information is not stored at the facilitator website after transmission of the payment information to the merchant.

5. The method of claim 3, further comprising, prior to receiving the content from the publisher, executing a service agreement prepared by the facilitator;
and wherein the service agreement sets forth at least one selected from the group consisting of:
terms by which the publisher and the merchant are to collaborate to sell the product; and
conditions under which the customer is willing to transact.

6. The method of claim 5, further comprising, prior to executing the service agreement, performing at least one selected from the group consisting of:
recruiting merchants;
recruiting publishers; and
collecting profiling information from at least one of a merchant and a publisher via an onboarding platform.

7. The method of claim 6, wherein the profiling information comprises at least one selected from the group consisting of:
automatic identification of fit;
manual generation of metadata; and
manual supervision of automatic identifications;
and wherein the method further comprises, prior to receiving the content, associating the product with the content by determining that the content rating of the content is suitable for association with the product.

8. The method of claim 2, further comprising:
displaying an advertisement for the product; and
responsive to third user input indicating interest in the product, displaying the transaction window.

9. The method of claim 2, wherein displaying the content for the user comprises displaying at least one of an animation and an icon in association with the content;
and wherein receiving the first user input comprises receiving user selection of the icon.

10. The method of claim 9, wherein displaying the content for the user further comprises displaying at least one of the animation and the icon superimposed on the content.

11. The method of claim 2, wherein receiving the second user input comprises receiving user selection of a purchase option displayed in the transaction window.

12. The method of claim 2, further comprising, prior to receiving the second user input, receiving third user input selecting the product from among a plurality of products offered for sale from within the transaction window.

13. The method of claim 1, wherein displaying the product information, receiving the second user input, and transmitting an order to purchase the product to the merchant are performed without navigating away from the displayed web page and without opening a new window and without opening a new tab.

14. The method of claim 1, further comprising:
routing information about the status of the order to at least one of the publisher and another entity.

15. A non-transitory computer-readable medium for selling products from a merchant via a publisher website hosted by a publisher, comprising instructions stored thereon, that when performed by a processor, perform the steps of:
receiving content from the publisher website, wherein the content is associated with a product;
causing an output device to display, for a user, a web page comprising the content, wherein the web page comprises a portion of the publisher website;
causing an input device to receive first user input from the user indicating interest in the product;
responsive to the first user input, receiving product information about the product from a merchant distinct from the publisher;
causing the output device to display the product information without navigating away from the publisher's website and without opening a new window and without opening a new tab;
causing the input device to receive second user input indicating a desire to purchase the product without navigating away from the publisher's website and without opening a new window and without opening a new tab; and
responsive to the second user input and without navigating away from the publisher's website and without opening a new window and without opening a new tab, causing an order to purchase the product to be transmitted to the merchant.

16. The non-transitory computer-readable medium of claim 15, wherein:
causing the output device to display the product information comprises causing at least one of a transaction frame and a transaction window containing the product information to be displayed, without navigating away from the publisher's website and without opening a new window and without opening a new tab; and
causing the input device to receive the product information comprises causing the input device to receive the product information via a facilitator distinct from the publisher and the merchant.

17. The non-transitory computer-readable medium of claim 15, wherein causing the input device to receive the product information comprises causing the input device to receive the product information via a facilitator distinct from the publisher and the merchant.

18. The non-transitory computer-readable medium of claim 17, wherein causing the order to purchase the product to be transmitted to the merchant comprises:
receiving the order to purchase the product at a facilitator website operated by the facilitator; and
initiating a conduit for transmission of at least one of payment information and identity information for the order to purchase the product to the merchant such that the payment information is not stored at the facilitator website after transmission of the payment information to the merchant.

19. The non-transitory computer-readable medium of claim 17, further comprising instructions stored thereon, that when performed by a processor, perform the steps of:
causing the output device to display an advertisement for the product; and
responsive to third user input indicating interest in the product, causing the output device to display the transaction window.

20. The non-transitory computer-readable medium of claim 17, wherein causing the output device to display the content for the user comprises causing the output device to display at least one of an animation and an icon in association with the content;
and wherein causing the input device to receive the first user input comprises causing the input device to receive user selection of the icon.

21. The non-transitory computer-readable medium of claim 15, wherein causing the output device to display the product information, causing the input device to receive the second user input, and causing the order to purchase the product to be transmitted to the merchant are performed without navigating away from the displayed web page and without opening a new window and without opening a new tab.

22. The non-transitory computer-readable medium of claim 15, further comprising instructions stored thereon, that when performed by a processor, perform the step of:
routing information about the status of the order to at least one of the publisher and another entity.

23. A system for selling products from a merchant via a publisher website hosted by a publisher, the system comprising:
a hardware processing device, configured to receive content from the publisher website, wherein the content is associated with a product;
an output device, communicatively coupled to the hardware processing device, configured to display, for a user, a web page comprising the content, wherein the web page comprises a portion of the publisher website;
an input device, communicatively coupled to the hardware processing device, configured to receive first user input from the user indicating interest in the product; and
a network transmission device, communicatively coupled to the hardware processing device;
wherein:
the hardware processing device is further configured to, responsive to the first user input, receive product information about the product from a merchant distinct from the publisher;
the output device is further configured to display the product information without navigating away from the publisher's website and without opening a new window and without opening a new tab;
the input device is configured to receive second user input indicating a desire to purchase the product, without navigating away from the publisher's website and without opening a new window and without opening a new tab; and
the network transmission device, is configured to, responsive to the second user input and without navigating away from the publisher's website and without opening a new window and without opening a new tab, transmit an order to purchase the product to the merchant.

24. The system of claim 23, wherein:
displaying the product information comprises displaying at least one of a transaction frame and a transaction window containing the product information, without navigating away from the publisher's website and without opening a new window and without opening a new tab; and
receiving the product information comprises receiving the product information via a facilitator distinct from the publisher and the merchant.

25. The system of claim 24, wherein receiving the product information comprises receiving the product information via a facilitator distinct from the publisher and the merchant.

26. The system of claim 25, wherein transmitting the order comprises:
receiving the order to purchase the product at a facilitator website operated by the facilitator; and
initiating a conduit for transmission of at least one of payment information and identity information for the order to purchase the product to the merchant such that the payment information is not stored at the facilitator website after transmission of the payment information to the merchant.

27. The system of claim 24, wherein the output device is further configured to:
display an advertisement for the product; and
responsive to third user input indicating interest in the product, display the transaction window.

28. The system of claim 24, wherein displaying the content for the user comprises displaying at least one of an animation and an icon in association with the content;
and wherein receiving the first user input comprises receiving user selection of the icon.

29. The system of claim 23, wherein displaying the product information, receiving the second user input, and transmitting an order to purchase the product to the merchant are performed without navigating away from the displayed web page and without opening a new window and without opening a new tab.

30. The system of claim 23, wherein the hardware processing device is further configured to route information about the status of the order to at least one of the publisher and another entity.
